(19) United States
(12) Patent Application Publication
(10) Pub. No.: US 2017/0098211 A1
(43) Pub. Date: Apr. 6, 2017

(54) SYSTEM AND METHOD FOR GIFT CARDS INTEGRATION WITH PAYMENT

(71) Applicant: @PAY IP HOLDINGS LLC, Wilmington, DE (US)

(72) Inventors: John P. KILLORAN, JR., Albuquerque, NM (US); Patrick L. KILLORAN, Jackson Heights, NY (US); Wauker Matthews, Baltimore, MD (US)

(73) Assignee: @PAY IP HOLDINGS LLC, Wilmington, DE (US)

(21) Appl. No.: 15/286,143

(22) Filed: Oct. 5, 2016

Related U.S. Application Data
(60) Provisional application No. 62/237,292, filed on Oct. 5, 2015.

(51) Int. Cl. G06Q 20/34; G06Q 20/32; G06Q 20/40; G06Q 20/22

(52) U.S. Cl. CPC G06Q 20/342; G06Q 20/227; G06Q 20/3255; G06Q 20/40

(57) ABSTRACT

A system and method for gift cards, account controls, and payment processor integration with email payment in an e-commerce system is disclosed. The system and method include receiving parameters, from a full-customer, for a sub-customer to access an account of the full-customer, wherein the full-customer provides an identifier of the sub-customer, receiving a confirmation from the sub-customer, transmitting an offer to the sub-customer, wherein the offer includes a mailto link and a token, receiving a message from the sub-customer, wherein the sub-customer selects the mailto link in the offer, checking the parameters set by the full-customer, and on a condition that the parameters are met, processing a payment.

### CROSS REFERENCE TO RELATED APPLICATION(S)

This application claims the benefit of 62/237,292 filed Oct. 5, 2015, which is incorporated by reference as if fully set forth.

### FIELD OF INVENTION

The present invention is related to electronic commerce systems. More particularly, the present invention is a system and method that aids management of electronic gift cards, shared accounts and payment processor integration with using email, SMS and social media based payments.

### BACKGROUND

The present state of online and instore checkouts require customers to provide sensitive card information either at the counter or on a browser. Email-based checkout requires that each customer and vendor register in order to use their bank account gift card or credit card.

Current credit, debit, and gift cards often require the customer's possession of a physical card which has all of the required information for payments to be made. An account can be easily compromised by the theft of the card or copying of its information. Currently, electronic gift cards are a popular way to give money instead of cash. The electronic gift cards may be used for a variety of vendors or a limited number of vendors, both in stores and online. The use of many of these gift cards may be contingent on the customer having physical possession of a plastic card or transferring the value to an online account.

Online vendors wishing to generate new business often miss out on gift card opportunities. Customers also fail to use gift cards or only partially use them. This is due to complications in how gift cards are distributed and redeemed online.

Therefore, a need exists, for a system that integrates directly with the payment processor or banking system may register all card holders, making them 4390713-1 eligible for email based checkout, that associates an email account, social media account, and/or phone number with the gift card, for added security to complete payments, would be a welcome feature in the marketplace, that allows for the gifting of an amount of money that is associated with an email address, phone number, or other identifier and facilitates secure transactions using those accounts would be welcome in the market place, and that allows a balance to be associated with an email address, phone number or social media account and redeemed based on the account holders access to the email, SMS, or social media account would streamline the process for users and gifters alike.

### SUMMARY

A system and method for gift cards, account controls, and payment processor integration with email payment in an e-commerce system are disclosed. The method includes receiving parameters, from a full-customer, for a sub-customer to access an account of the full-customer, wherein the full-customer provides an identifier of the sub-customer, receiving a confirmation from the sub-customer confirming the received parameters, transmitting an offer to the sub-customer, wherein the offer includes a mailto link and a token, receiving a message from the sub-customer, wherein the sub-customer selects the mailto link in the offer, checking the parameters set by the full-customer, and on a condition that the parameters are met, processing a payment.

A system and method for gift cards, account controls, and payment processor integration with email payment in an e-commerce system are disclosed. The method including transmitting a gift offer to a full-customer, wherein the gift offer includes a mailto link and a token, receiving a message from the full-customer to transmit a gift to a sub-customer, the message sent when the full-customer selects the mailto link in the gift offer, authenticating the message and decoding the token, checking parameters set by the full-customer, and on a condition that the parameters are met, transferring the gift to the sub-customer from the full-customer.

A system and method for gift cards, account controls, and payment processor integration with email payment in an e-commerce system are disclosed. The method including transmitting an offer to a sub-customer, wherein the offer includes a mailto link and token, receiving a response message from the sub-customer, wherein the sub-customer selects the mailto link in the offer, authenticating the response message and decoding the token, checking parameters set by a full-customer, and on a condition that the parameters are met, processing a payment.

A system and method for gift cards, account controls, and payment processor integration with email payment in an e-commerce system are disclosed. The method including receiving a request for a check of available funds from a vendor, transmitting an offer to a customer, wherein the offer includes a mailto link and a token, receiving a response message from the customer verifying a purchase, wherein the customer selects the mailto link in the offer, authenticating the message and decoding the token and on a condition that the parameters are met, processing a payment for the purchase.

### BRIEF DESCRIPTION OF THE DRAWINGS

A more detailed understanding may be had from the following description, given by way of example in conjunction with the accompanying drawings wherein:

FIG. 1 illustrates a system diagram for integrating email, SMS and social media based payments with gift cards shared accounts and payment processor integration with multiple customers;

FIG. 2 illustrates an example email message that solicits the purchase of goods from a vendor;

FIG. 3 illustrates an email message for placing an order;

FIG. 4 illustrates an advertisement email message that solicits a donation;

FIG. 5 illustrates an email message for ordering a donation;

FIG. 6 is a transactional flow diagram illustrating the use of a short URL link with token authentication in e-commerce system;

FIGS. 7A and 7B are diagrams illustrating ways to register customers and vendors;

FIG. 8 is a transactional flow diagram that illustrates the setting of parameters by a full-customer for a sub-customer to access their account and make payments;

FIG. 9A is a transactional flow diagram that illustrates the e-commerce system managing bank accounts or redemption accounts based on deposits made from one customer account to another via a web-based registration;

FIG. 9B is an example of one possible interface for purchasing a gift card;

FIG. 10A is a transactional flow diagram that illustrates the e-commerce system managing bank accounts or redemption accounts based on deposits made from one customer account to another by messaging;

FIG. 10B is an example of an offer message to buy a gift card

FIG. 10C is an example of a response message;

FIG. 10D is one example of a notification that the sub-customer may receive informing them of the gift card;

FIG. 11 is a transactional flow diagram that illustrates a customer accessing funds or redeeming benefits from their account with the e-commerce system;

FIG. 12 is a diagram illustrating the ordering by the e-commerce system of different payment methods for a full-customer with a sub-customer associated with their account;

FIG. 13 is a transactional flow diagram that illustrates an in store vendor requesting a payment from a customer account with the e-commerce system;

FIG. 14 is a transactional flow diagram that illustrates an in store customer initiating a gift card payment with the e-commerce system;

FIG. 15 is a transactional flow diagram that illustrates an in store vendor requesting authentication of a message with the e-commerce system for the purposes of gift card redemption.

### DETAILED DESCRIPTION OF THE PREFERRED EMBODIMENT(S)

An email-based checkout that integrates directly with the payment processor or banking system may register all card holders, making them eligible for email based checkout. A system that associates an email account, social media account, and/or phone number with the gift card, for added security to complete payments, would be a welcome feature in the marketplace. A system that allows for the gifting of an amount of money that is associated with an email address, phone number, or other identifier and facilitates secure transactions using those accounts would be welcome in the market place. A system that allows a balance to be associated with an email address, phone number or social media account and redeemed based on the account holders access to the email, SMS, or social media account would streamline the process for users and gifters alike.

The e-commerce system defines different levels of access by the designations of categories such as full-customer and sub-customer. A full-customer is the holder of the credit card account or banking account and can access those funds via the e-commerce system without restrictions. A full-customer may gift funds by sending the funds to the sub-customer's account. A sub-customer is a user of the e-commerce system who has been granted access to the full-customer's account, but with restrictions. Sub-customer may receive funds into their account from the full-customer. The e-commerce system provides full-customers the ability to limit the scope of the funds provided allowing use with parameters defined by full-customer.

Disclosed is a method for selling, purchasing, delivering, refilling and spending gift cards. The term gift card, e-gift card, gift certificate, gift voucher and gift token are interchangeable. A gift card is a stored value money or funds which are prepaid that may be issued by the e-commerce system, banking unit payment processor, vendor or other third party. Gift cards are redeemable for products services or may be used to make donations. A physical plastic or paper card may not be required. Access to an email account or other identifier may serve as a method to access the funds.

All embodiments described below may be integrated with an email service provider, customer relationship management, or directly with a payment processor. Payment processing may occur in any number of ways using multiple gateways, credit cards, debit cards, direct carrier billing, and automatic clearinghouse. Although the description below focuses on the use of email messaging, social media, and SMS, other networks may also be substituted. The configuration of the Email Payment Gateway (also referred to as the e-commerce system) may vary based on client needs. A method and system allow vendors to send emails to customers where customers may make payments for specific amounts by selecting mailto links that are associated with each amount and sending the email to the e-commerce system. Each mailto link may hold a token generated by the e-commerce system. The e-commerce system may authenticate the email and decode the token. The e-commerce system provides vendors with a series of controls that manage and streamline the process of registering customers.

The embodiments described below may also be integrated with an email service provider, customer relationship management, or directly with a payment processor. Payment processing may occur in any number of ways using multiple gateways, banks, credit cards, debit cards, gift cards, direct carrier billing, automatic clearing houses, or virtual currency. Although the description below focuses on the use of email, Short Message Service (SMS), and social media networks may also be used. Although some examples and discussion herein generally use SMS, other texting formats may be substituted for SMS including Extensible Markup Language (XMPP), Session Initiation Protocol (SIP), Voice over Internet Protocol (ViOP), multimedia messaging service (MMS), Messaging Queuing Telemetry Transport (MQTT), and Apple Push Notification Service (APNS) used in services such as Whatsapp, Viber, Facebook Messenger, iMessage and other forms Internet Telephony Protocols. The configuration of the system may vary accordingly.

One function of an Email Payment Gateway may be to generate payment tokens and then to decode the tokens when sent back to the gateway. An email with a token usually provides the information required for the completion of a transaction. This method often requires the management of numerous tokens and an inflexible process for vendors. A system that limits the amount of information in a token, for example, a minimum amount, or requires no tokens at all, and pulls additional required information automatically from other sources would be welcome in the market place.

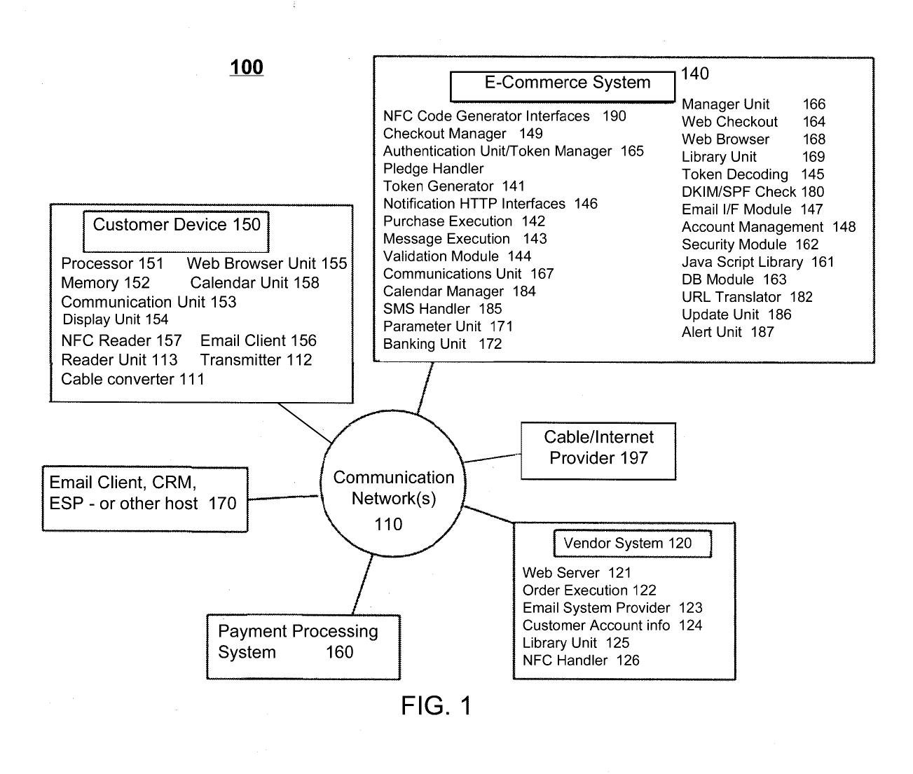

FIG. 1 illustrates a systems diagram for integrating email, SMS, and social media based payments with gift cards, shared accounts, and payment processor integration with multiple customers. FIG. 1 illustrates a system diagram of an email-based website checkout system 100. The example system 100 shown in FIG. 1 may be used for e-commerce transactions. The example system 100 includes a customer device 150, a vendor server 120, an e-commerce system 140, a banking server (not shown), a payment processing system 160, and an email service provider 170 that may communicate over one or more wired and/or wireless communication networks 110. The wired or wireless communication networks 110 may be public, private or a combination of public or private networks.

The customer device 150 may be, for example, a cellular phone, a smartphone, a desktop computer, a laptop computer, a tablet computer, television or any other appropriate computing device. The customer device 150 may utilize short message service (SMS) messages, multimedia messaging service (MMS), social media apps, web browsing, and or email. For example, social media apps may include Facebook, Twitter, GooglePlus+, LinkedIn, Instagram, Pinterest, Swapchat, Tumblr, and the like. The customer device 150 includes a processor 151, memory 152, a communications unit 153, a display unit 154, a web browser unit 155, which may communicate data to/from the web server module(s) in the vendor server 120 and payment server 160, email client 156, and near field communication (NFC) reader 157. The web browser unit 155 may include and/or communicate with one or more sub-modules that perform functionality such as rendering HTML (including but not limited to HTML5), rendering raster and/or vector graphics, executing JAVASCRIPT, and/or rendering multimedia content.

Alternatively or additionally, the web browser unit 155 may implement Rich Internet Application (RIA) and/or multimedia technologies such as ADOBE FLASH and/or other technologies compatible with Internet based communications. The web browser unit 155 may implement RIA and/or multimedia technologies using one or web browser plug-in modules (e.g., ADOBE FLASH), and/or using one or more sub-modules within the web browser unit 155 itself. The web browser unit 155 may display data on one or more display devices (not depicted) that are included in, or connected to, the customer device 150, such as a liquid crystal display (LCD) display or monitor. The customer device 150 may receive an input from a user from an input device (not depicted) that is included in, or connected to, the customer device 150, such as a keyboard, a mouse, a microphone or a touch screen, and provide data that indicates the input to the web browser unit 155.

The display unit 154 may be a smart phone, computer screen or television.

The customer device 150 may also include a cable converter 111, transmitter 112, and reader unit 113. Cable converter 111 and transmitter 112 are shown within the customer device 150, although in certain situations cable converter 111 and transmitter 112, each individually or together may be located in other parts within the system 100. For example cable converter 111 and transmitter 112 may in certain implementations be located within vendor system 120, or even within a third party system, for example.

Cable converter 111 may be any form of electronics that converts transmitted or otherwise conveyed signals to those signal displayed on a television or other display. For example, cable converter 111 may be an electronic tuning device that transposes/converts any of the available channels from a cable television service to an analog RF signal on a single channel, usually VHF channel 3 or 4, or to a different output for digital televisions such as HDMI. Cable converter 111 may include descrambling to manage carrier-controlled access restriction to various channels. Cable-ready televisions and other cable-aware A/V devices such as video recorders can similarly convert cable channels to a regular television set, and the cable converter 111 is included within these devices. The task of cable converter 1111 is to convert a television channel from those transmitted over the CATV wire, for example.

Transmitter 112 is any transmitter that can transmit information including the described token or link within a defined distance to customer device 150 via reader unit 113.

The customer device 150 may also include a calendar unit or calendar application, and a messaging unit, also referred to as a SMS or social media application 159.

Calendar unit 158 may also include or be referred to as calendar software or a calendar application. Calendar unit 158 may include calendaring software that at least includes or provides users with an electronic version of a calendar. Additionally, the software may provide an appointment book, address book, and/or contact list. These tools are an extension of many of the features provided by time management software such as desk accessory packages and computer office automation systems. Calendaring is a standard feature of many PDAs, EDAs, and smartphones. The software may be stored or house locally on a computing device or customer device 150, often designed for individual use, e.g. Lightning extension for Mozilla Thunderbird, Microsoft Outlook without Exchange Server, or Windows Calendar, or may be a networked-based software that allows for the sharing of information between users, e.g. Mozilla Sunbird, Windows Live Calendar, Google Calendar, or Microsoft Outlook with Exchange Server.

SMS or social media application 159 may be any application that provides access to texting including SMS or to social media application wither directly or using a web link.

Parameter unit 171 includes a portion of the e-commerce system 140 designated to determine how payments and accounts can be handled by the e-commerce system 140 in certain ways. As will be described herein, access and payments may be designated under certain conditions. Parameter unit 171 manages this designation and determines how a payment may occur.

Banking unit 172 includes a portion of the e-commerce system 140 allowing for payments to be received and held in an account of a customer 150, for example. Banking unit 172 may be responsible for managing account of customers 150 within the e-commerce system 140 including maintaining information regarding funds in an account or designated for an account.

The vendor system 120 may include a web server 121, order execution unit 122, an email system provider 123, customer account info 124, a library unit 125, and an NFC handler 126. The vendor system may be substituted for a financial management system as illustrated in the examples described herein.

The web server 121 provides a website that may be accessed by a customer device 150. The web server 121 may implement HTTP protocol, and may communicate Hypertext Markup Language (HTML) pages and related data from the website to/from the customer device 150 using HTTP. The vendor server 120 may be connected to one or more private or public networks (such as the Internet), via which the web server 121 communicates with devices such as the customer device 150. The web server 121 may generate one or more web pages, may communicate the web pages to the customer device 150, and may receive responsive information from the customer device 150.

The web server 121 may be, for example, an NGINX server, an APACHE HTTP server, a SUN-ONE Web Server, a MICROSOFT INTERNET Information Services (IIS) server, and/or may be based on any other appropriate HTTP server technology. The vendor server 120 may also include one or more additional components or modules (not depicted), such as one or more load balancers, firewall devices, routers, switches, and devices that handle power backup and data redundancy.

The vendor system 120 may also include one or more additional components or modules (not depicted), such as one or more load balancers, firewall devices, routers, switches, and devices that handle power backup and data redundancy.

The order execution unit 122 is configured to receive instructions included in received messages and executes orders on behalf of the vendor system 130.

The memory may be configured to store information associated with e-commerce transactions. This may include inventory information, information used to generate web pages, customer information, and other e-commerce data.

The e-commerce system 140 may include a token generator 141, a purchase execution module 142, a message execution module 143, a validation module 144, a database module 163, a token decoder 145, a notification HTTP module 146, an email interface module 147, an account management unit 148, checkout manager 149, web checkout 164, JAVA script library 161, a security module 162, authentication unit/token manager 165, manager unit 166, communications unit 167, web browser 168, libraries 169, DKIM/SPF check 180, a Universal Resource Locator (URL) translator 181, and an NFC code generator interface 190. While only one vendor system 120 is shown communicating with the e-commerce system 140, this is shown as an example only. The e-commerce system 140 may communicate with an internal or external email service provider (ESP) 170 and an internal or external payment processing system 160. The e-commerce system 140 may communicate with multiple vendor systems 120.

Similarly, vendors may register with the e-commerce system 140. The e-commerce system 140 may provide the vendor system 120 with a public key and private key to be used in token transaction in accordance with the methods described herein. When a transaction is attempted (e.g. for invoices and payments), the e-commerce system 140 decodes the token, authenticates the sender of the email, which may allow the transaction to be processed. While the e-commerce system 140 is depicted as a separate entity in FIG. 1, this is shown as an example only. The e-commerce system 140 may be controlled and/or co-located with the vendor system 130, and/or the email service provider 170.

The token generator 141 may generate tokens for use in e-commerce transactions. Tokens may be encrypted or plain text strings which contain information to perform a transaction when sent to the e-commerce system 140. A token may be one or multiple encrypted strings, files, passwords, cyphers, plain text or other data which may contain information used to perform or authenticate a transaction. While FIG. 1 shows the token generator 141 as being a part of the e-commerce system 140, it may be hosted by any trusted party with access to the private key. For example, the banking server may include a token generator 141. A token may include one or more of the following parameters or other parameters not listed below:

Private-key: The private key provided by the e-commerce system 140.

Public-key: E-commerce system's 140 public key, provided by the e-commerce system 140.

Auth-key: Any additional data that may be used to authenticate the transaction, including, but not limited to, biometric identification, location data and other fraud detection systems.

Partner-id: The partner ID given provided by the e-commerce system 140.

Environment: The environment the vendor wants to generate buttons for. This distinguishes whether the token is being used in a testing environment or in the live environment (and running real transactions).

Type: The type of token to generate (e.g. bulk, email-targeted, etc.). There are multiple types of tokens that a token generator 141 may generate and decode. For example, site tokens may be used for website transactions, email tokens for minimum-of-clicks email payments, and universal tokens for email validations.

Card: The card token associated with the recipient of this token. When a customer is registered with the e-commerce system 140, the vendor receives a credit card token—a unique identifier that references the specific card associated with that customer and vendor. When the vendor is generating a token to submit to e-commerce system 140, they may include the card token as a customer identifier.

Email: The email associated with the receipt of this token.

URL: The Signup URL the recipient may go to if customer doesn't have payment information registered with e-commerce system 140.

Amount: The amount a customer should be charged for the transaction the token is generated for.

User-data: Data to pass back as a reference. This data may include custom data that the vendor may want to pass through the e-commerce system 140 and receive back when a transaction has completed. It may include an item reference number or SKU, customer address, or other piece of data that is not required by e-commerce system 140 to complete a transaction, but that the vendor wants associated with that transaction.

Expires: Expiration date for token, integer value of seconds since epoch.

Header-user-agent: The HTTP_USER_AGENT from the request header. HTTP headers are sent as part of a request from a customer's web browser unit within customer device 150 for a piece of information. These headers define the parameters that the web browser unit is expecting to get back. The user-agent is the identifier of the software that is submitting the request—typically the identifier of the web browser unit that is requesting the content.

Header-accept-language: The HTTP_ACCEPT_LANGUAGE from the request header. The accept-language is the acceptable language for the response—e.g. the language in which the web browser unit is requesting the content be sent back.

Header-accept-charset: The HTTP_ACCEPT_CHARSET from the request header. The accept-charset is the character sets that are acceptable for the response—e.g. the character set in which the web browser unit is requesting the content be sent back.

IP-address: The IP address of the token recipient.

In one example, a bulk token may omit the card and email fields, thereby allowing for the tokens to be shared. Additionally, or alternatively, a bulk token may include the card field and/or email field but the e-commerce system 140 may be configured to ignore those fields and/or other fields based on the type field.

The purchase execution module 142 facilitates the execution of payments between a customer and a vendor.

The message execution module 143 is configured to analyze received messages and communicate with the token decoder 145 to determine if the received message is valid and to identify the request embedded in the message (e.g. request for purchase of goods.) If the token decoder 145 indicates the token is valid, the message execution module 143 may then access the account management unit 148 to verify a transaction.

The database module 163 serves as a database to store information that may be accessed by the e-commerce system 140.

The token decoder 145 may be configured to decode tokens received from external sources, such as a vendor system 120 or a customer device 150.

The validation module 144 may serve to authenticate received emails, using the DomainKeys Identified Mail (DKIM) and/or Sender Policy Framework (SPF) protocols. For example, SPF allows a domain owner to add a file or record on the server that the recipient server cross-checks. Similarly, DKIM may be used to embed information within the email. While these specific validation/authentication protocols are discussed herein, any known validation/authentication protocol may be used and the use of the DKIM/SPF protocol is used only to enhance the understanding of the reader by using a specific possible validation/authentication protocol.

Generally, SPF is an email validation system designed to detect email spoofing by providing a mechanism to allow receiving mail exchangers to check that incoming mail from a domain is being sent from a host authorized by that domain's administrators. The list of authorized sending hosts for a domain may be published in the Domain Name System (DNS) records for that domain in the form of a specially formatted TXT record. Sender Policy Framework is described in IETF publication RFC 7208, which is incorporated by reference as if fully set forth.

The Simple Mail Transfer Protocol (SMTP) permits any computer to send an email claiming to be from any source address. SPF allows the owner of an Internet domain to specify which computers are authorized to send email with sender addresses in that domain, using Domain Name System (DNS) records. Receivers verifying the SPF information in TXT records may reject messages from unauthorized sources before receiving the body of the message.

The sender address is transmitted at the beginning of the SMTP dialog. If the server rejects the sender, the unauthorized client should receive a rejection message, and if that client was a relaying message transfer agent (MTA), a bounce message to the original sending address may be generated. If the server accepts the sender, and subsequently also accepts the recipients and the body of the message, it should insert a Return-Path field in the message header in order to save the sender address.

Generally, DKIM is an email validation system designed to detect email spoofing by providing a mechanism to allow receiving mail exchangers to check that incoming mail from a domain is authorized by that domain's administrators. A digital signature included with the message may be validated by the recipient using the signer's public key published in the DNS. DKIM is the result of merging DomainKeys and Identified Internet Mail. Prominent email service providers implementing DKIM include Yahoo, Gmail, AOL and FastMail. Any mail from these organizations should carry a DKIM signature.

More specifically, both, signing and verifying modules are usually part of a mail transfer agent (MTA). The signing organization may be a direct handler of the message, such as the author, the originating sending site or an intermediary along the transit path, or an indirect handler such as an independent service that provides assistance to a direct handler. In most cases, the signing module acts on behalf of the author organization or the originating service provider by inserting a DKIM-Signature: header field. The verifying module typically acts on behalf of the receiver organization.

DKIM is independent of Simple Mail Transfer Protocol (SMTP) routing aspects in that it operates on the RFC 5322 message—the transported mail's header and body—not the SMTP envelope defined in RFC 5321. Hence, the DKIM signature survives basic relaying across multiple MTAs. DKIM allows the signer to distinguish its legitimate mail stream. This ability to distinguish legitimate mail from potentially forged mail has benefits for recipients of e-mail as well as senders, and “DKIM awareness” is programmed into some e-mail software.

The “DKIM-Signature” header field, by way of example, may include a list of “tag=value” parts. Tags are short, usually only one or two letters. The most relevant ones are b for the actual digital signature of the contents (headers and body) of the mail message, bh for the body hash, d for the signing domain, and s for the selector. The default parameters for the authentication mechanism are to use SHA-256 as the cryptographic hash and RSA as the public key encryption scheme, and encode the encrypted hash using Base64. The receiving SMTP server uses the domain name and the selector to perform a DNS lookup. For example, given the signature:

DKIM-Signature: v=1; a=rsa-sha256; d=example.net; s=brisbane;
c=relaxed/simple; q=dns/txt; 1=1234; t=1117574938; x=1118006938;
h=from:to:subject:date:keywords:keywords;
h=MTIzNDU2Nzg5MDEyMzQ1Njc4OTAxMjM0NTY3ODkwMTI=;
b=dzdVyOfAKCdLXdJOc9G2q8LoXSlEniSbav+yuU4zGeeruD00lszZVoG4ZHRNiYzR.

A verifier queries the TXT resource record type of brisbane._domainkey.example.net. The selector is a straightforward method to allow signers to add and remove keys whenever they wish—long lasting signatures for archival purposes are outside DKIM's scope. Some more tags are visible in the example:

v is the version,

a is the signing algorithm,

c is the canonicalization algorithm(s) for header and body,

q is the default query method,

l is the length of the canonicalized part of the body that has been signed,

t is the signature timestamp,

x is it's expire time, and

h is the list of signed header fields, repeated for fields that occur multiple times.

The DKIM-Signature header field itself is always implicitly included in h.

The data returned from the verifier query is also a list of tag-value pairs. It includes the domain's public key, along with other key usage tokens and flags. The receiver may use this to then decrypt the hash value in the header field and at the same time recalculate the hash value for the mail message (headers and body) that was received. If the two values match, this cryptographically proves that the mail was signed by the indicated domain and has not been tampered with in transit.

Signature verification failure does not force rejection of the message. Instead, the precise reasons why the authenticity of the message may not be proven should be made available to downstream and upstream processes. Methods for doing so may include sending back a message, or adding an Authentication-Results header field to the message as described in RFC 7001, which is incorporated as if fully set forth.

While DKIM and SPF protocols are discussed herein, validation module 144 may perform any authentication and validation type protocols. DKIM and SPF are used to provide examples of such validation protocols that may be performed in validation module 144.

The notification HTTP module 146 delivers notices of events to external systems, such as an HTTP endpoint the vendor configures to update their internal database when a transaction is executed.

An email interface module 147 may be configured to parse emails for action by the e-commerce system 140.

The account management unit 148 is configured to manage accounts registered with the e-commerce system 140. A customer or vendor, wishing to complete a transaction with an e-commerce system 140 may register his/her email address and payment information with the e-commerce system 140. The account management unit 148 may be configured to store a customer registry and a vendor registry.

The security module 162 may be configured to perform additional security measures to prevent unauthorized access to the system or fraud.

E-commerce system 140 may also include a pledge handler 183, a calendar manager or calendar application 184, a SMS handler 185, an update unit 186, and an alert unit 187. SMS handler 185 is a device or element within the e-commerce system 140 that can handle SMS communication and can receive, decode/encode SMS communications. An update unit 186 provides updates within the e-commerce system 140. Alert unit 187 is a unit that provides alerts within the e-commerce system 140.

Pledge handler 183 is an element designed to handle pledges. This may include the portion of the system that receives identification of an intent to pay or perform and monitors and tracks such a pledge.

Calendar manager or calendar application 184 may be of the same type as calendar unit 158 of customer device 150. Calendar 184 may be linked or in communication with calendar 158. Calendar application 184 may be any of the types of calendar described above with respect to calendar 158, the type of which may not be influenced by the type of calendar of calendar 158.

The email service provider 170 may be associated with the vendor system 120, the e-commerce system 140, or may be a third party entity. The email service provider 170 may be configured to provide email marketing services. The email service provider 170 may further be configured to provide tracking information showing the status of email sent to each member of an address list. The email service provider 170 may further be configured to segment an address list into different interest groups or categories to send targeted information. The email service provider 170 may also parse messages based on the secondary system of email-targeted tokens. The email service provider 170 may also be configured to send trigger emails based on responses from the vendor system 120 or customer behavior. The email service provider 170 may further be configured to create or use templates generated by the e-commerce system 140. The templates may be used for sending information to contacts. Email service provider 170 may include a customer interface that allows a customer to adjust the template or it may be integrated with external sources (e.g. vendor system 120 or e-commerce system 140). The email service provider 170 may comprise a send engine (not shown), which allows vendors to distribute their message that may be received by one or more customer device(s) 150. The email service provider 170 may further include a tool for generating mailto links, graphic buttons, and tokens. The email service provider 170 may be configured to dynamically customize the content of emails that are sent out, to tailor personalized information and mailto links.

The banking server (not shown) may be controlled by a third party system bank. The e-commerce system 140 may communicate with the banking server to verify that the customer has adequate funds or credit for the requested payment. For example, the banking server may be a controlled by VISA, AMERICAN EXPRESS, MASTERCARD or any other banking or financial network that a customer may use for online payment. The banking server may be an automatic clearing house services (ACS). The banking server may be an interface for a centralized or decentralized virtual currency system or protocol such as frequent flyer miles, “reward” points, or Bitcoin.

Credit card vault 195 may also be included in E-Commerce System 100. Credit card vault 195 may include any credit clearing house. This is shown as being independent from any of the other entities in the system including customer device 150, e-commerce system 140, vendor system 120, payment processing system 160, and banking server (not shown) for example. Credit card vault 195 may be housed, received input or be a combination of the clearinghouse portion of any of the other entities in the system including customer device 150, e-commerce system 140, vendor system 120, payment processing system 160, and banking server (not shown) and is shown as a separate entity only for ease of understanding and clarity.

The email-based e-commerce system 140 may allow vendors to send advertising emails or bills with a mailto link associated with a specific product offer (or payment amount) and select the mailto link and generate a response email by selecting the mailto link. This response email contains a token and is addressed to the e-commerce system 140. Once sent, this response email confirms the customer's payment for the product (or prepayment of a bill) by parsing the information in the token. The e-commerce system 140 processes the payment and notifies the vendor system 120 and the customer device 150. The e-commerce system 140 may comprise a token generator 141 as well as components for processing the tokens and components for processing the payments and a system for notifying the vendor system 120 of the transaction details.

The functionality of the offer, mailto link, and response email is described in U.S. Pat. No. 9,152,980 which issued on Oct. 6, 2015 entitled EMAIL-BASED E-COMMERCE, which is a continuation of U.S. Pat. No. 8,775,623 which issued on Jul. 8, 2014 entitled SYSTEM AND METHOD FOR EMAIL-BASED E-COMMERCE, and U.S. Pat. No. 9,058,591 which issued on Jun. 16, 2015 entitled EMAIL-BASED DONATIONS, which applications are incorporated by reference as if fully set forth.

Referring back to the example system in FIG. 1, the payment processing system 160 may be an independent third party operated unit, it may be located in the e-commerce system 140 or the vendor system 120.

While the example system shown in FIG. 1 shows the e-commerce system 140 comprising the token generator 141, this is shown as an example only. The vendor system 120 may also include a token generator 141 that allows vendors to directly create tokens. In another example, a third party may have a token generator 141 to create tokens for use by the vendor system 120.

System 100 may not require the vendor system 120 to host the token generator 141 on their system. System 100 uses the web browser's ability to transmit a message securely between two frames of a page and validating the URLs of those two pages.

Mailto links in the email messages may include one or any combination of the following fields: a “mailto:” and/or “to” field that indicate one or more email addresses of recipients of the new message; a “Copy To” or “CC” field that indicates one or more email addresses of recipients to whom a copy of the new message should be sent; a “Blind Copy To” or “BCC” field that indicates one or more email addresses of recipients to whom a “blind” copy of the new message should be sent; a field that indicates the subject of the new message; and a field that indicates the body of the new message. The mailto links may be defined according to the format described in Internet Engineering Task Force (IETF) RFC2368, which is incorporated by reference as if fully set forth herein. The mailto link may be accessed with a corresponding short URL.

The e-commerce system 140 may include a database of registered customers, such as for payment processing. The e-commerce system 140 may identify a customer by their email address and may decode tokens included in the content of an email and process payments based on the data in the token. A vendor that is associated with the e-commerce system 140 may send emails with the tokens generated for processing by the e-commerce system 140. When generating tokens, a related URL checkout page with a matching offer is generated. This allows vendors via vendor system 120 to send emails with payment options, including payments for product offers, donations, services and gift cards, for example, with each offer associated with a token and a URL checkout page. The token is associated with a mailto link. A customer may activate the mailto link by selecting (or “clicking on”) the link and send the message to the e-commerce system 140. The e-commerce system 140 may then identify the email address and decode the token. If the e-commerce system 140 determines that the email address is not registered in the database, the e-commerce system 140 sends an email back to the customer with a URL link that is a checkout. This checkout is prepopulated based on the customer's mailto link selection based on the content of the token. The URL captures the payment information and registry information. The e-commerce system 140 updates the database once the new customer is registered. In future transactions, the email address of the customer is identified as registered by the e-commerce system 140 and the payment is processed exclusively through an email payment gateway.

An email-based e-commerce system 100, as described herein, allows an email payment opportunity. This may include an email advertisement offering a product or service which is sent to customers and contains one or more mailto links. Each mailto link may relate to an item (e.g. service or product). If the mailto link is selected by a customer, an email message associated with an item or items is generated. Within that generated email message is a token that includes encoded information such as the purchase amount, the merchant, or an item identifier. The information contained in the token includes details for both the completion of email transaction and details that provide context and direction for the process of completing a transaction when the details included within the token are not sufficient. This may include details about the composition of a page to collect more information from the customer (where the required fields and information about those fields are stored directly in the token), a pointer to a location where the composition of a page to collect more information is stored (where the required fields and information about these fields are indirectly referenced by data in this token for retrieval at a later time), or a pointer or description of a routine to execute in case of failures (e.g. a response email in the case of product unavailability). This mailto link may be generated by a vendor through a web interface tool, or by using the e-commerce system 100 to programmatically create either the token or the full mailto link.

For a customer to complete an email transaction, the customer's payment information may be contained in the email e-commerce system database 163. In order to determine if the customer's payment information is in database 163 the token may be decoded to recognize the customer when the email arrives at the e-commerce system 140. The vendor sends the first email via the vendor system 120. The customer via customer device 150 responds by activating a mailto link by sending the response to the e-commerce system 140. If the customer is registered and the incoming email is authenticated, when the token is decoded, the transaction is processed.

If the customer is not registered, a web checkout page may be needed. Additional information may be encoded within the email token that describes a web checkout page for the email offer. The vendor's email may thereby serve multiple purposes. One enables the email to perform as an email payment, if the customer is registered, and another enables the unregistered customer to be sent a web checkout 164. The web checkout 164 may be prepopulated with additional information based on the customers' original selection that is decoded from the token. The additional information included within the token identifies remote resources, which may include an input display and validation components. The remote resource may function as a plugin, as a reference to information stored in a database, or as a hook into the execution of an independent function.

When the web checkout 164 page is being loaded by the customer, the input display may provide the requirements for displaying the field on the form, including field name, entry box length, and other properties of the input field.

When the form has been filled out by the customer and is submitted, these form fields are sent to the validation resource to confirm that the information entered meets the formatting, length, data type, and any other requirements of the field. If validation resource returns a “pass” condition for the form, submission continues to the e-commerce system 140. If the validation resource returns a “fail” condition for any data on the form, error messaging may be displayed to the customer, to enable correction of the one or more particular inputs that were identified as incorrect and resubmission again.

These remote resources may be created to describe standard information that may be used across numerous merchants, or they may be used to define custom information that may be used for a single merchant.

Using this system 100, a vendor via vender system 120 may not be required to expend additional computer programming effort because it relies on the email e-commerce system 140. If the offer web page is linked to the email purchase opportunity, the vendor may not be required to modify any existing systems or processes to register customers with the email e-commerce system 140. The vendor may not need to segment their email lists into registered and unregistered customers and the customers are not aware of the distinction within the content of the email. The distinction between customers occurs by virtue of the system relieving both the vendor and the customer of any excess choices or distinctions. The vendor may create offers manually via a web interface, and the email e-commerce system 140 may handle the aspects of the transaction, from receiving the order request, facilitating the payment processing, storing relevant transaction data, sending a receipt, and displaying transaction data to the vendor.

The vendor may integrate directly with an API. The vendor may maintain existing payment flows separate from their email e-commerce solution, or the vendor may use the email e-commerce system as a full-featured payment system for both web and email transactions without doing any software development. Presenting the customer with a clear process that seamlessly migrates the customer to adopt an email-based checkout process eases the customer into a new technology where transactions happen by email instead of on a URL. This system 100 provides a vendor with a more automated or customized way of handling elements that may be achieved through the use of the email e-commerce system 140.

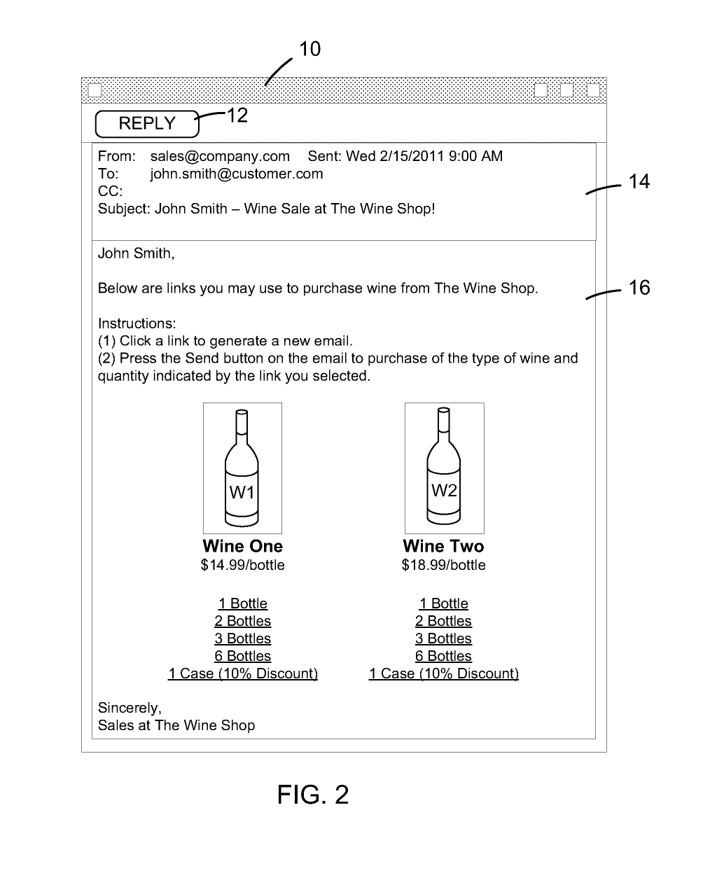

FIG. 2 illustrates an example email message that solicits the purchase of goods from a vendor. FIG. 2 shows an email display window 10 that may be used by the email client module of customer device 150 to display a first example email message from the message processing module. The email display window 10 may include a reply button 12, a control area 14, and a message body area 16. The control area 14 may display control and/or header information associated with the email message, such as the email addresses of the sender and recipient of the message. According to this example, the control area 14 shows that the sender of the message has the email address “sales@company.com.” This is an email address that may be associated with an account used by the e-commerce system 140 for the communication of email messages. Further to this example, the control area 14 shows that the email address of the example recipient of the message (John Smith) is “john.smith@customer.com.” The control area 14 may also display information such as a subject of the email message and the time the email message was sent. The reply button 12 may respond to user input to generate a new display element (not depicted) to respond to the email message.

The message body area 16 may display the body of the email message. As shown in FIG. 2, the message body area 16 may display an example email message that shows information related to two example products (Wine One and Wine Two) that are being offered for sale by an example vendor (The Wine Shop). The message body area 16 includes a picture of a bottle of each type of wine, as well as the price for a bottle of each type of wine. The message body area 16 also includes, under the picture of the bottle of Wine One, a number of mailto links, such as the “1 Bottle,” “2 Bottles,” “3 Bottles”, “6 Bottles,” and “1 Case (10 percent Discount)” links. The message body area 16 also includes similar links under the picture of the bottle of Wine Two. These links may be defined according to the mailto URI scheme or other appropriate format, and each may describe a new email message that may be generated by the email client module of customer device 150 when that link is selected.

The “1 Bottle” link beneath the picture of the Wine One bottle may include information that, if selected, generates an email message that, if received by the e-commerce system 140, will indicate to the e-commerce system 140 that John Smith may like to purchase one bottle of Wine One. As a further example, Wine One may have a product identifier of “0005,” and John Smith may have a customer identifier of “0777.” According to this example, the “1 Bottle” link may describe an email message that is addressed to an email account that is associated with the e-commerce system 140, and that includes a message body that includes the identifier for John Smith (“0777”), an identifier of the selected product (“0005”), and an identifier of the quantity that John Smith may like to order (in this example, a single bottle). Alternatively or additionally, the email message described by the link may include information such as text that describes the order, an identifier of the vendor (in this example, The Wine Shop), an email campaign identifier, and/or other information. Similarly, the “2 Bottles” link beneath the picture of the Wine One bottle may include information that describes an email message that, if received by the e-commerce system 140, will indicate to the e-commerce system 140 that John Smith may like to purchase two bottles of Wine One. According to this example, the “2 Bottles” link may be defined as follows:

<a href=“mailto:sales@company.com?subject=Purchase percent 20from percent 20Wine percent 20Shop percent 20 and body=You percent 20have percent 20created percent 20an percent 20order percent 20for percent 20two percent 20bottles percent 20of percent 20Wine percent 20One. percent 20Press percent 20the percent 20Send percent 20button percent 20to percent 20complete percent 20the percent 20order. percent 0A percent 0AProductID0005 percent 20QualifierNA percent 20Qty0002 percent 20CustomerID0777 percent 20CampaignID0003” target=“blank”>2 Bottles</a>mailto:sales@company.com?Subject=“Press send to pay $42.99 to Wine Shop”? body=“TEXT XXX-XXX-XXX-XXX”

In addition, the token identifier may be part of the To: address, or any other portion of an address field, or the address field itself. This token may be, for example, of the form: ex: mailto:payment-id-XXX-XXX-XXX@payments.atpay.com?Subject=“Press send to pay $42.99 to Wine Shop”?body=“TEXT”. Once this token identifier reaches the e-commerce system 140, the e-commerce system 140 may perform a look-up of the actual token in order to parse the offer details. This process is described in greater detail below.

Similarly, the “3 Bottles,” “6 Bottles,” and “1 Case (10 percent Discount)” links beneath the picture of the Wine One bottle indicate corresponding information for three bottles, six bottles, and one case of bottles, respectively. Additionally, the “1 Bottle,” “2 Bottles,” “3 Bottles,” “6 Bottles,” and “1 Case (10 percent Discount)” links under the Wine Two bottle indicate corresponding information for Wine Two as that described above with respect to the mailto links relating to Wine One.

The email client module of customer device 150 may receive a user input that indicates that one of the links displayed in the message body area 16 is selected. The user input may be, for example, a mouse click, keyboard input, or any other type of input that indicates that a link is selected. The email client module of customer device 150 may, in response to this user input, generate and display an order email message as specified by the selected link.

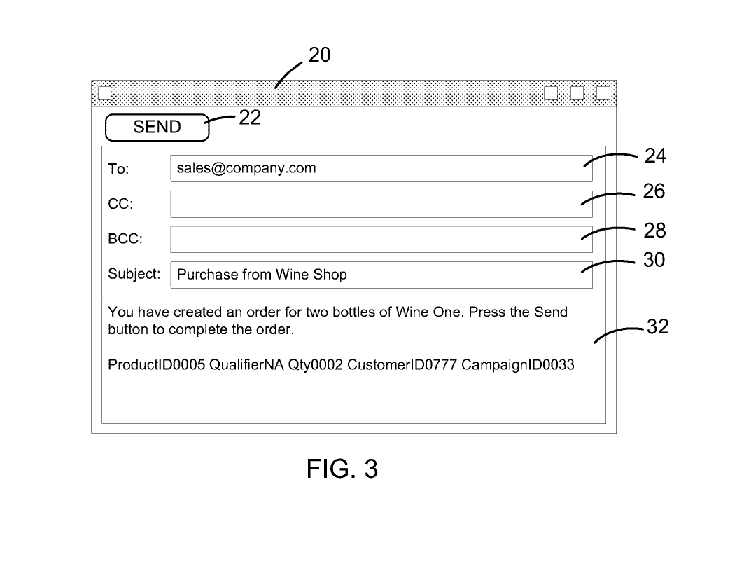

FIG. 3 illustrates an email message for placing an order. FIG. 3 shows an example message composition window 20 that may be displayed in response to a selection of a link from the message body area 16 of the email display window 10 of FIG. 2. The message composition window 20 of FIG. 3 may include a Send button 22, a To area 24, a CC area 26, a BCC area 28, a Subject area 30, and a message body area 32. The Send button 22 in the message composition window 20 of FIG. 3 may be responsive to input from a user such as a mouse click, keyboard input, or any other type of input. The different areas 24, 26, 28, 30, 32 in the message composition window 20 display different portions of an email message. For example, the To area 24 includes text that indicates email addresses to which the email message is addressed, while the message body area 32 displays the contents of the body of the email message. Each or any of these different areas 24, 26, 28, 30, 32 may be editable based on user input. Changes to the contents of these areas 24, 26, 28, 30, 32 may change the corresponding portion of the email message.

FIG. 3 shows an example wherein the “2 Bottles” link beneath the picture of the Wine One and described above with reference to FIG. 2 is selected. The To area 24 indicates that the message is addressed to sales@company.com. The Subject area 30 indicates that the subject of the message is “Purchase from Wine Shop.” The CC area 26 and BCC area 28 are blank. Continuing the example of FIG. 3, Wine One product has a product identifier of “0005” and John Smith has a customer identifier of “0777.” Accordingly, the message body area 32 includes the text “ProductID0005” and “CustomerID0777.” To indicate that the user has selected the purchase of two bottles, the message body area 32 includes the text “Qty0002.” Further, the message body area 32 includes the text “CampaignID0033,” indicating that the order is associated with an email campaign with an identifier of “0033.”

In an instance where a different link from the message body area 16 of FIG. 2 is selected, the display areas 24, 26, 28, 30, 32 in the message composition window 20 may include contents specified by the selected different link. For example, in an instance where a link related to Wine Two is selected, the message body area may not include the text “ProductID0005,” but may include text that indicates the corresponding identifier for Wine Two.

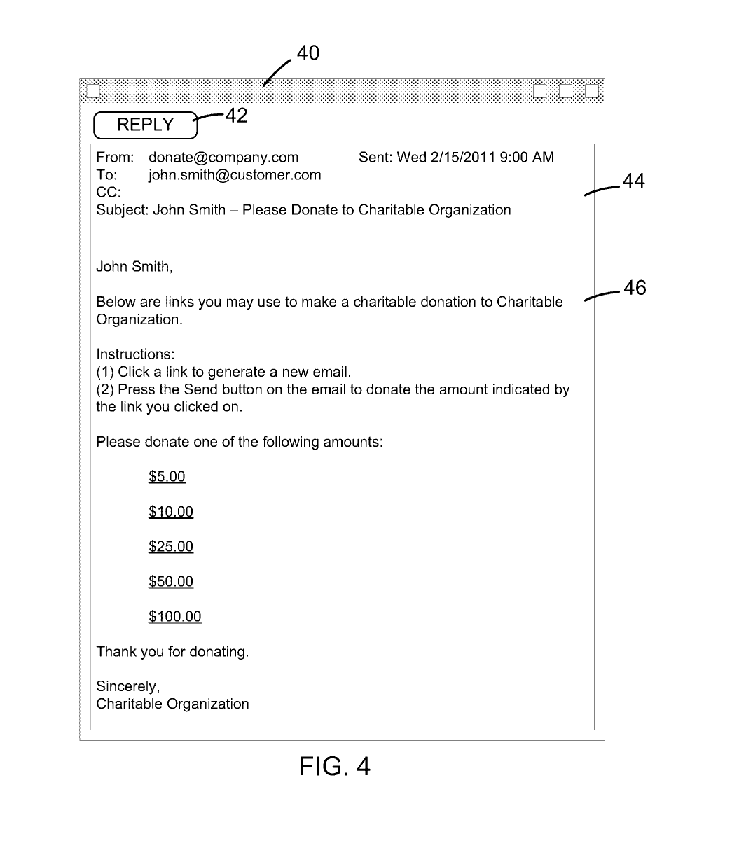

FIG. 4 illustrates an advertisement email message that solicits a donation. FIG. 4 shows an email display window 40 that may be used by the email client module of customer device 150 to display a second example email message from the message processing module. The email display window 40 includes a Reply button 42, a control area 44, and a message body area 46. These display areas 42, 44, 46 may possess similar and/or analogous characteristics and/or perform similar functionality as corresponding display areas 12, 14, 16 in the message composition window 20 of FIG. 2. According to the example of FIG. 4, the control area 44 shows that the sender of the message has the email address “donate@company.com.” This is an email address that may be associated with an account used by the e-commerce system 140 for the communication of email messages. Further to this example, the control area 44 shows that the email address of the example recipient of the message (John Smith) is “john.smith@customer.com.”

As shown in FIG. 4, the message body area 46 of the email display window 40 may display an example email message that shows information related the solicitation of donations for an example non-profit organization (“Charitable Organization”). The message body area 46 also includes mailto links, such as the “$5.00,” “$10.00,” “$25.00,” “$50.00,” and “$100.00” links. These links may possess similar and/or analogous characteristics, and/or include similar and/or analogous information, as the mailto links described above with reference to FIG. 2. The “$5.00” link describes an email message that, if received by the e-commerce system 140, will indicate to the e-commerce system 140 that John Smith may like to donate $5.00 to Charitable Organization. Similarly, the “$10.00,” “$25.00,” “$50.00, and $100.00” links describe email messages with corresponding information for $10.00, $25.00, $50.00, and $100.00 donations, respectively.

The email client module of customer device 150 may receive a user input that indicates that one of the links displayed in the message body area 46 is selected. The email client module of customer device 150 may, in response to this user input, generate and display an order email message as specified by the selected link.

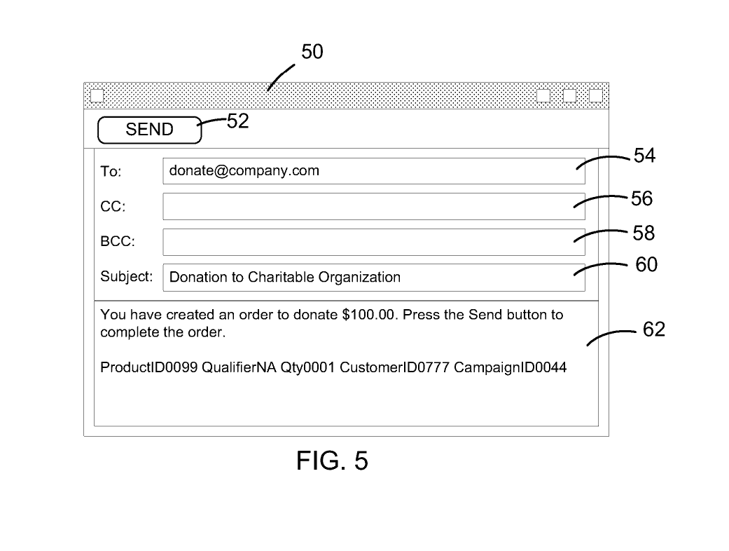

FIG. 5 illustrates an email message for ordering a donation. FIG. 5 shows an example message composition window 50 that may be displayed in response to a selection of a link from the message body area 46 of the email display window 40 of FIG. 3. The message composition window 50 of FIG. 5 may include a Send button 52, a To area 54, a CC area 56, a BCC area 58, a Subject area 60, and a message body area 62. These display elements 52, 54, 56, 58, 60, 62 may possess similar and/or analogous characteristics and/or perform similar functionality as corresponding display areas 22, 24, 26, 28, 30, 32 in the message composition window 20 of FIG. 3.

FIG. 5 shows an example wherein the “$100.00” link from the message body area 46 of the email display window 40 of FIG. 4 is selected. The To area 54 indicates that the message is addressed to donate@company.com. The Subject area 60 indicates that the subject of the message is “Donation to Charitable Organization.” The CC area 56 and BCC area 58 are blank. According to this example, a donation of $100.00 to Charitable Organization has a product identifier of “0099,” and John Smith has a customer identifier of “0777.” Accordingly, the message body area 62 includes the text “ProductID0099” and “CustomerID0777.” Further, the message body area 62 includes the text “CampaignID0044,” indicating that the order is associated with an email campaign with an identifier of “0044.”

The email client module of customer device 150 may send the generated order email message to the e-commerce system 140. This may be performed in response to input from a user of the customer device 150. As one example, the email client module of customer device 150 may, in response to a selection of the Send button 52 in the message composition window 50 of FIG. 5, transmit an order email message based on the contents of the fields 54, 56, 58, 60, 62 in the message composition window 50. As another example, the email client module of customer device 150 may, in response to a selection of the Send button 52 in the message composition window 50 of FIG. 5, transmit an order email message based on the contents of the display areas 54, 56, 58, 60, 62 in the message composition window 50.

A token may be located within the To: Cc: or Bcc fields of a response email. This token may take the form of a short token, for example. The e-commerce system 140 may generate the short token that is located in the To: field, or any other field, for example, as part of the email address. When the vendor system 130 requests that the token generator 141 generate a mailto link with the identifiers and token, the token generator 141 may generate a “short lookup token” and the “long token” encoded with the identifiers. The short lookup token may be associated with the long token and may be required or otherwise needed to access the information in the long token index. The short token index may be sent in an email to the customer device 150 as a mailto link. The customer using the customer device 150 selects the mailto link and generates the response email addressed to the e-commerce system 140. The short lookup token may be built into the address of the response email. The short lookup token may be of the form:

payment-id-74E4DE00-51E2-457B-8C0B-648640EF232D@payments.atpay.com, for example.

When the customer using customer device 150 sends the email and the e-commerce system 140 receives the email and authenticates the customer's email address, the e-commerce system 140 may also determine using the short lookup token included in email address of the e-commerce system 140 the long token associated therewith. When the long token is determined, the e-commerce system 140 decodes the long token and processes the payment. The use of the short token allows for a less convoluted field in the email address and eliminates the need for the token to be located in the body field.

The short token lookup is not necessarily required in this system, as the transactions may be processed with the long token either in the address field, another field, or in the body of the response email. The use of the short lookup token may lessen the one-to-one correlation between the token and the actual offer and/or transaction details, as that correlation may be more direct in the long token embodiment.

It should be understood that many variations are possible based on the disclosure herein. Although features and elements are described above in particular combinations, each feature or element may be used alone without the other features and elements or in various combinations with or without other features and elements.

The methods or flow charts provided herein may be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

A system is described that uses the e-commerce system 140 to process emails for making payments. As shown in FIG. 1, a single payment processing system is described. The present invention's flexibility and control offers vendors a choice of which payment processor to use. Additionally, a payment processor may be a vendor and offer payments by email. Payment processors and payment gateways may integrate the e-commerce system 140 and restrict access to other payment processors and gateways.

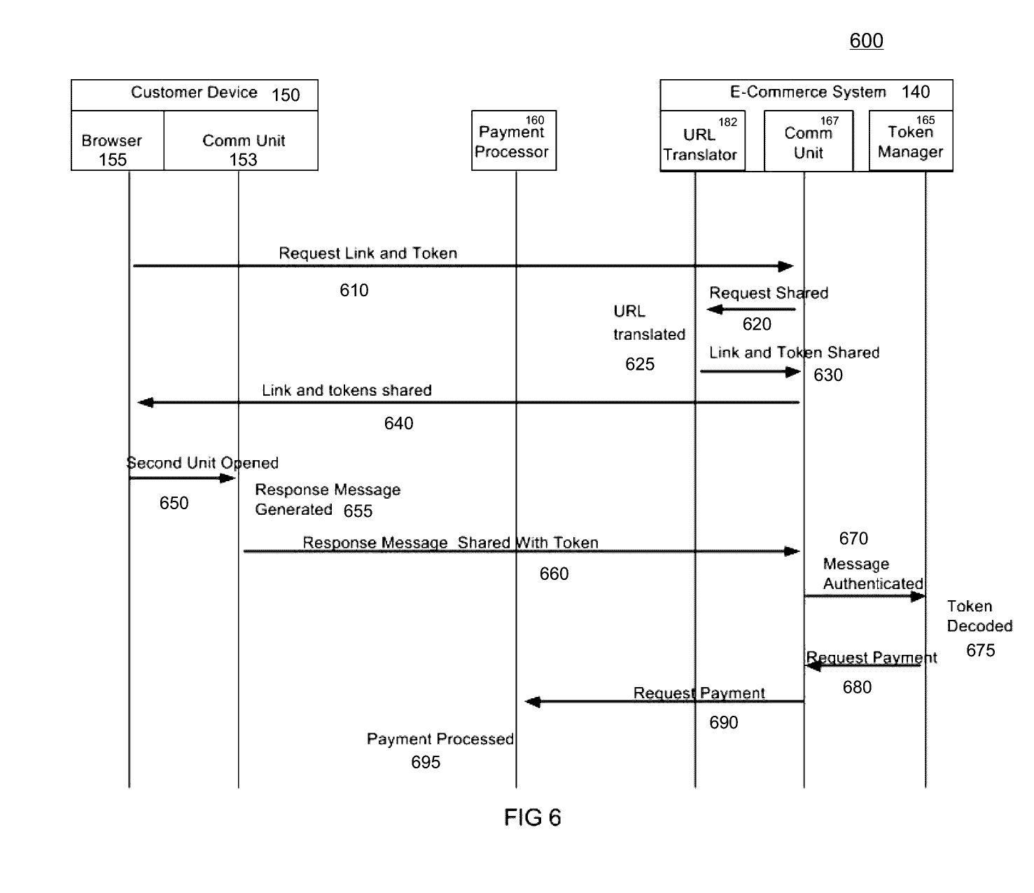

FIG. 6 is a transactional flow diagram 600 illustrating the use of a URL link, or short URL with token authentication in e-commerce system 100. In the depicted embodiment, a web browser 155 is utilized by the customer to request a link at step 610 that triggers a message to confirm payment. Various prompts might trigger the web browser 155 to request the link from the e-commerce system 140. For example the customer may select a URL link in another application that opens the web browser 155 or alternatively the customer may be in a web-based checkout where the customer selects the link that then opens the web browser 155. Opening the web browser 155 triggers a request from communication unit 167 for a mailto link and token at step 610. The request may be a series of requests or require the e-commerce system 140 to tally an amount due of the customer. E-commerce system 140 may also require a lookup of other required information. The communication unit 167 shares the request with the URL translator 182 at step 620. The URL translator 182 translates the URL link at step 625 and shares the corresponding link and token with the communication unit 167 at step 630. This token may be a short token that corresponds to a longer token. The communication unit 167 shares the link and token with the browser 155 at step 640, triggering the messaging unit 159 at step 650 to generate the response message with the token at step 655. The opening of the browser 155 may not be visible to the customer on customer device 150. The response message is addressed and sent to the e-commerce system 140 communication unit 167 with the token at step 660. The token may be located anywhere in any field of the message. The communication unit 167 authenticates the message at step 670 and shares the token with the token manager 165 to decode the token at step 675. If the token is a short token, it may need to be matched with a corresponding long token. The long token may require additional decoding (not shown). If either the authentication or the token decoding does not meet requirements, the customer via customer device 150 may receive a response message requesting an additional confirmation or a URL link that navigates the customer device 150 to a signup URL and/or checkout. If all requirements are met, the token manager 165 notifies the communication unit 167 that requirements are met and requests payment at step 680. The communication unit 167 requests payment at step 690 with the payment processor 160. The payment is processed at step 695, and updates and notifications are sent.

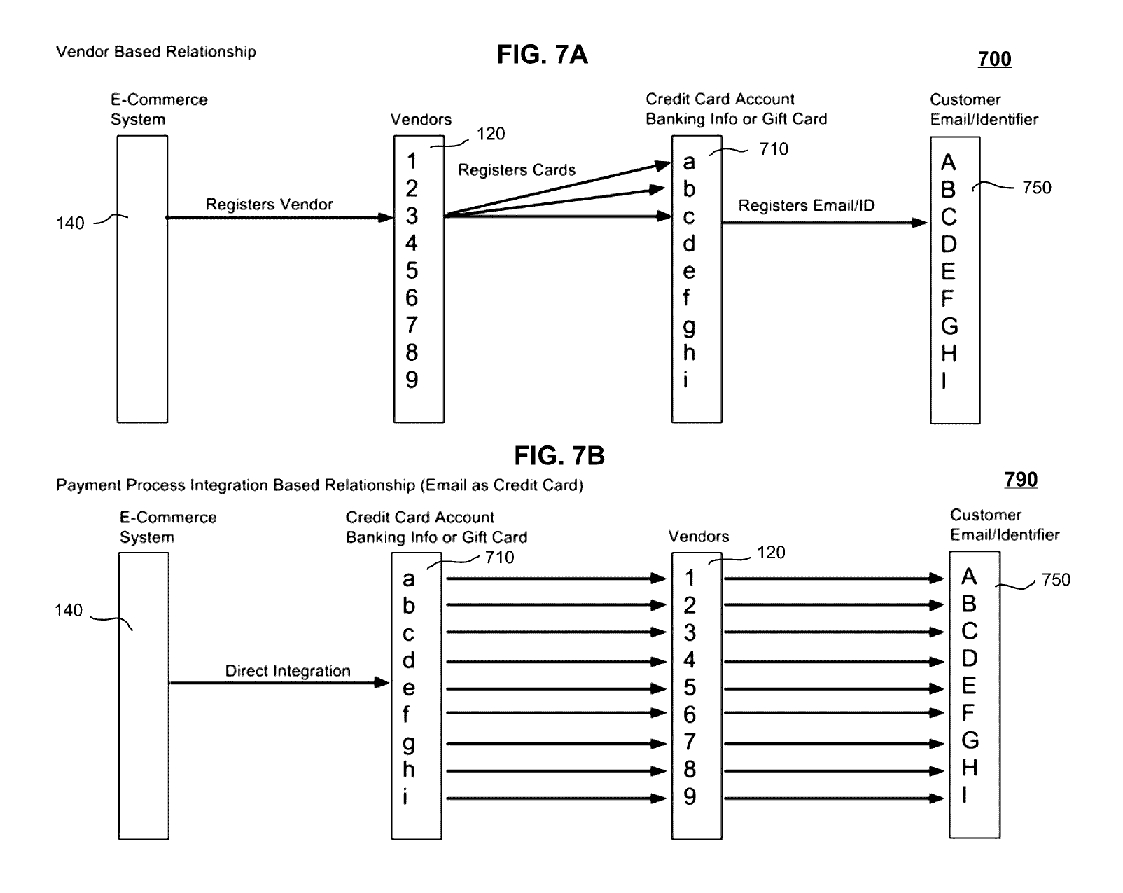

FIGS. 7A and 7B are diagrams 700, 790 illustrating ways to register customers and vendors 120. FIG. 7A is a diagram 700 that illustrates the e-commerce system 140 integrating with one vendor 120 at a time and then requesting each customer 750 to register with the e-commerce system 140. The registration requires the input of information such as credit card, gift card, or bank account information 710. In this configuration, the email address or other identifier may be used to approve payments to only the vendors 120 that the customer has registered directly with despite the fact that the credit card or bank may be used by competing vendors in a conventional web-checkout or for an in store purchase.

FIG. 7B is a diagram 790 that illustrates the e-commerce system 140 integrating with the payment processor or banking unit so that when the customer registers for their credit card, gift card, or bank account, the customer is automatically associated with an email, phone number, or social media account 750. All vendors 120 that accept the cards or customers holding accounts 710 are eligible for an e-mail based checkout.

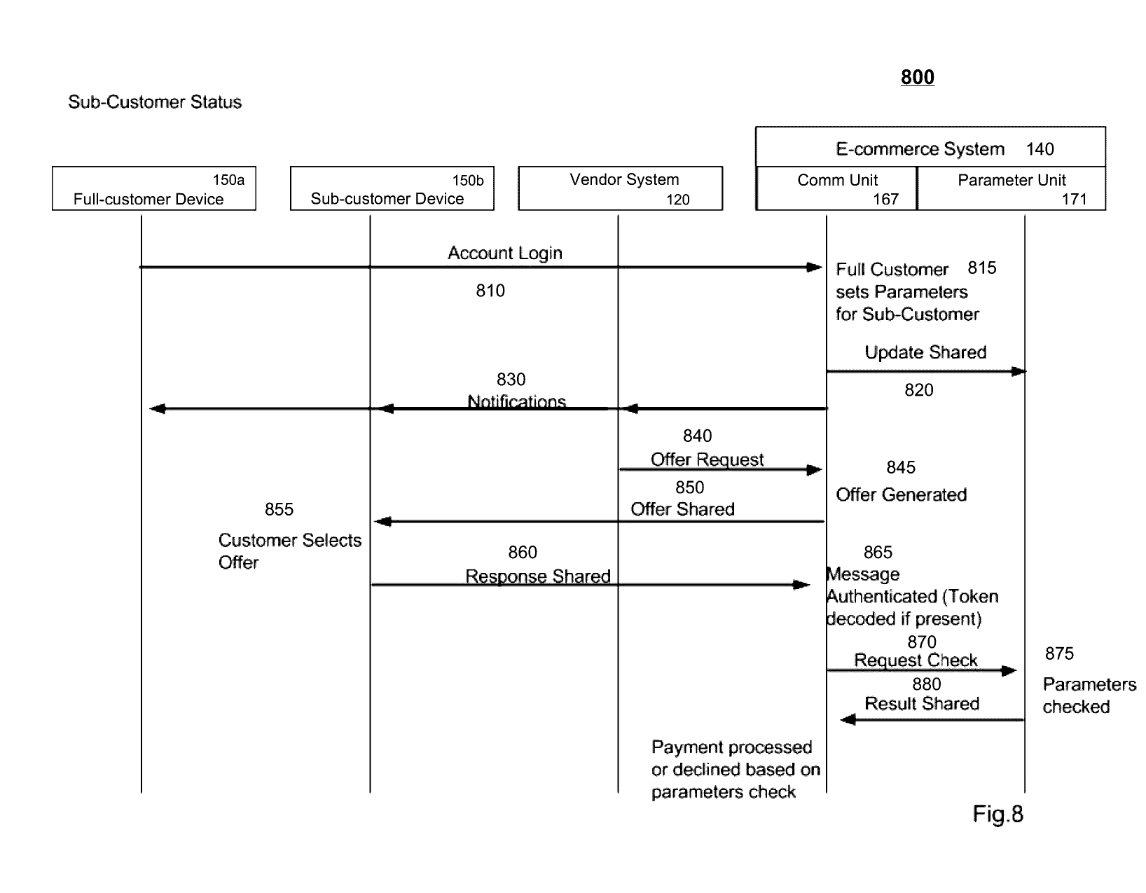

FIG. 8 is a transactional flow diagram 800 that illustrates how a full-customer 150a may set parameters for a sub-customer 150b to access their account and make payments. This allows one customer (full-customer 150a) to provide payment for another customer (sub-customer 150b) on a limited basis. This would be applicable within the business of gift cards allowing for a way to deliver and spend the gift card. It also allows for an easier way to replenish the gift card. The full-customer 150a gives the gift card to the sub-customer 150b. A physical gift card may not be required. The full-customer 150a accesses their account with the e-commerce system 140 at step 810 and sets the parameters for the sub-customer 150b at step 815. The full-customer 150a may provide an email, phone number, and/or other identifier of the sub-customer 150b. For example, a parameter may be a limit on the amount of money spent within 30 days. The process may require the sub-customer 150b to confirm via SMS, social media, or email (not shown). The parameters are shared with a parameter unit 171 of the e-commerce system 140 at step 820. Notifications are sent out at step 830. For example, the sub-customer 150b may receive a message announcing that they have been given an e-gift card by the full-customer 150a which can be used with the vendor 120. The vendor 120 makes a request for an offer at step 840 from the e-commerce system's communication unit 167.

The e-commerce system 140 generates the offer information at step 845. This may be in the form of a mailto link with a token used in an email campaign, a link, or a request used in an SMS, social media posting, or email message. The e-commerce system 140 shares the offer message with the sub-customer's device 150b at step 850. The offer message may contain a token. The offer message may contain a mailto link addressed to the e-commerce system 140 with a token or a URL link as described in FIG. 6. The offer message may be an email with a mailto link and a token or an SMS or social media post with a link. The sub-customer 150b views the offer and makes a selection at step 855. A response message addressed to the e-commerce system 140 is generated. The sub-customer 150b shares the response message with the e-commerce system's communication unit 167 at step 860. This response message may contain a token. The communication unit 167 authenticates the message and decodes the token, if present, at step 865. The communication unit 167 requests a check from the parameter unit 171 at step 870. The parameters may be checked in the parameter unit 171 at step 875. The parameter unit 171 shares the customer information at step 880 identifying whether or not the transaction can be made. On a condition that the transaction does not meet the requirements in the parameter unit 171, the e-commerce system 140 may send the sub-customer 150b a URL link that may navigate the sub-customer 150b to a sign-up page where they may input banking, credit card information, or other required information and complete the payment and register with the e-commerce system. Alternatively, on a condition that the transaction does not meet the requirements in the parameter unit 171, the e-commerce system 140 may send the full-customer 150a a URL link that may navigate the full-customer 150a to a sign-up page where they may input banking, credit card information, or other required information and complete the payment. On a condition that the parameters are met, the payment is processed and notifications are sent out at step 885.

Although in diagram 800, example offers and notifications are sent out by the e-commerce system 140, these offers or access to response messaging may be sent from the vendor 120 or another party. Although in diagram 800 there is one full-customer 150a and one sub-customer 150b there may be any number of full-customers 150a and sub-customers 150b. It is possible that a full-customer 150a may grant full-customer rights to another email address. It is also possible that a full-customer 150a may also be a sub-customer 150b of another full-customer 150a.

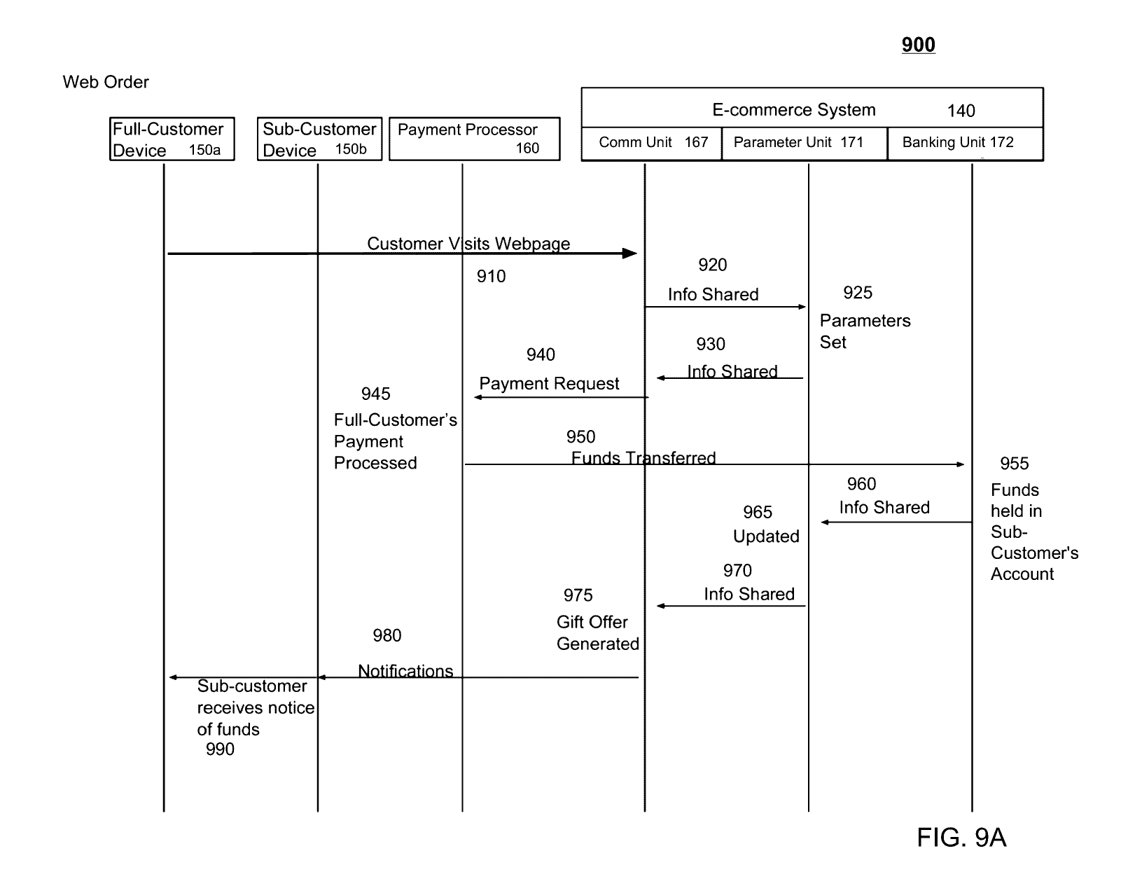

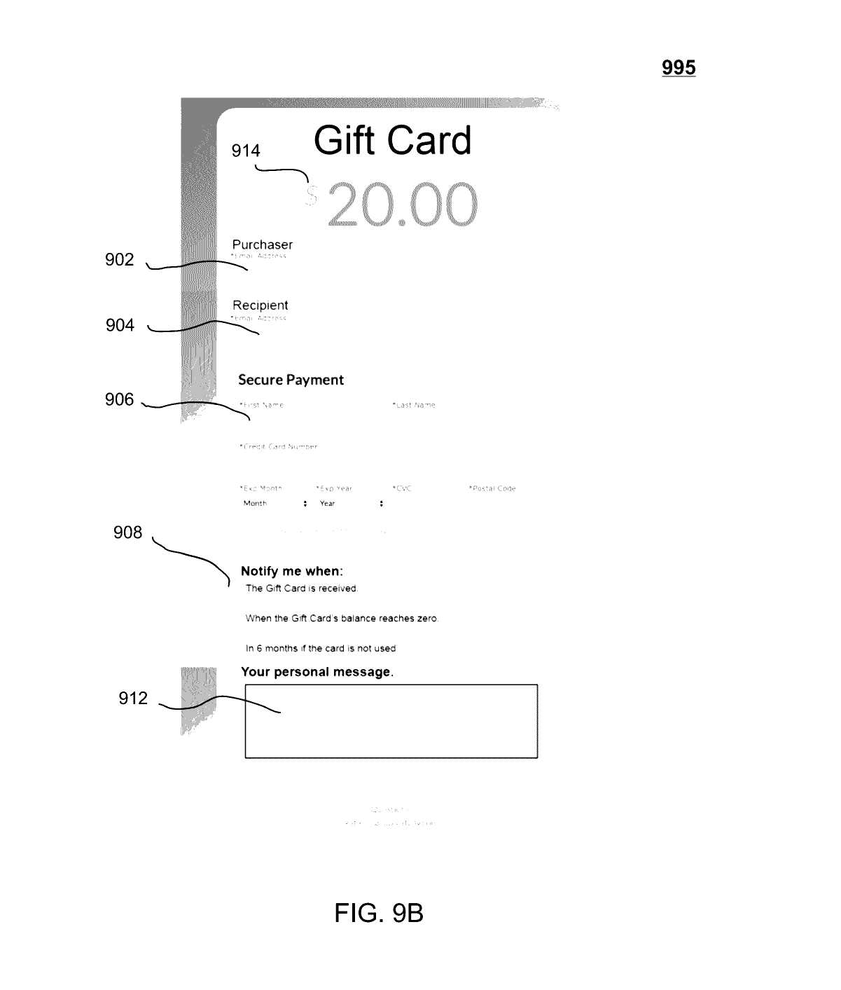

FIG. 9A is a transactional flow diagram 900 that illustrates how the e-commerce system 140 manages bank accounts or redemption accounts based on deposits made from one customer account to another via a web-based registration. In diagram 900, the full-customer 150a gives a gift card to a sub-customer 150b. The customer using the customer device visits the e-commerce system's web interface at step 910 and fills out the required information.

FIG. 9B is an example of one possible interface 995. This information may be registration information or additional information to registration process. Required information may be the customer's email address 902 and credit card or bank account information 906, the email address of the sub-customer 904 and the amount 914 desired to gift to the sub-customer. The customer may be able to provide notification instructions 908 and may attach a personal message 912.

Returning to FIG. 9A, the communication unit 167 registers the customer 150 as a full-customer 150a and shares the information with the parameter unit 171 at step 920. The parameter unit 171 is updated and the parameters set at step 925. The information is shared with the communication unit 167 at step 930. This shared information may include a payment request. The communication unit 167 shares the payment request at step 940 with the payment processor 160. The payment processor 160 charges the full-customer's credit card or bank account at step 945. The funds are transferred at step 950 to the banking unit 172 of the e-commerce system 140 and held in the sub-customer's 150a account at step 955. The banking unit 172 updates the parameter unit 171 sharing the information at step 960. The parameter unit 171 updates at step 965 and shares the information with the communication unit 167 at step 970. The communication unit 167 may generate a gift card message at step 975 and share that notification with the sub-customer 150b informing the sub-customer 150b of the gift and notifying the full-customer 150a that the message has been sent at steps 980 and 990.

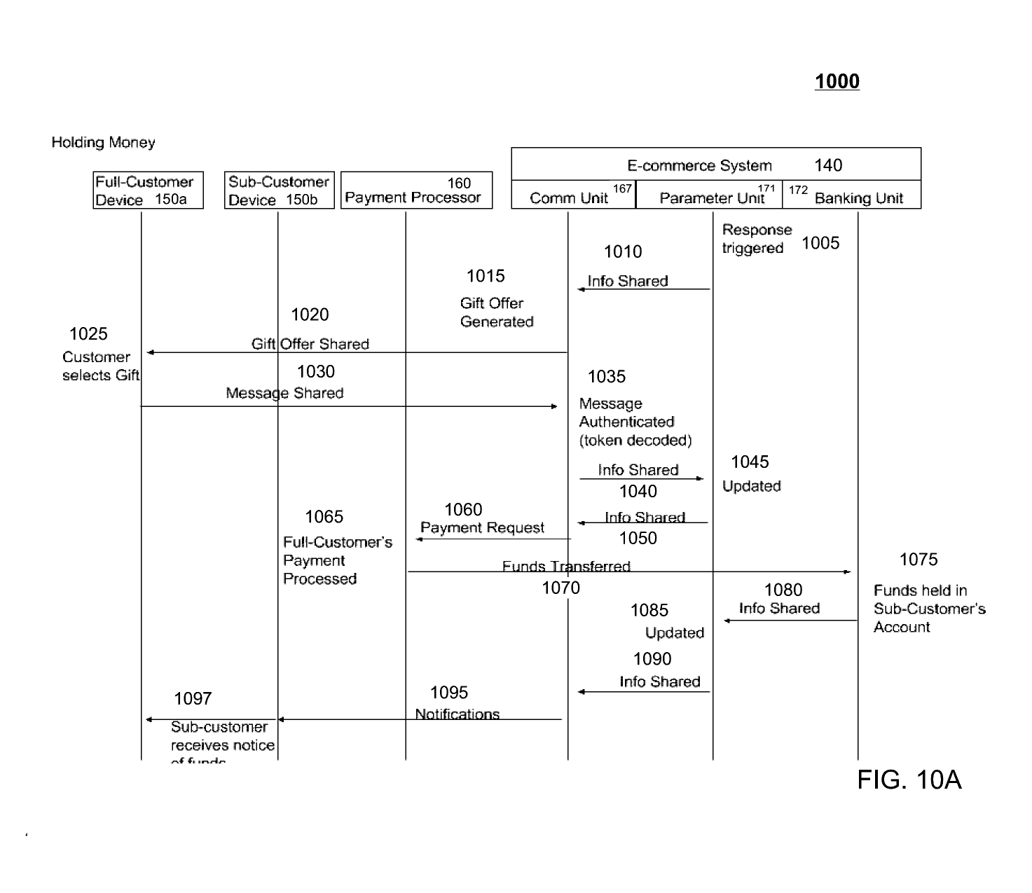

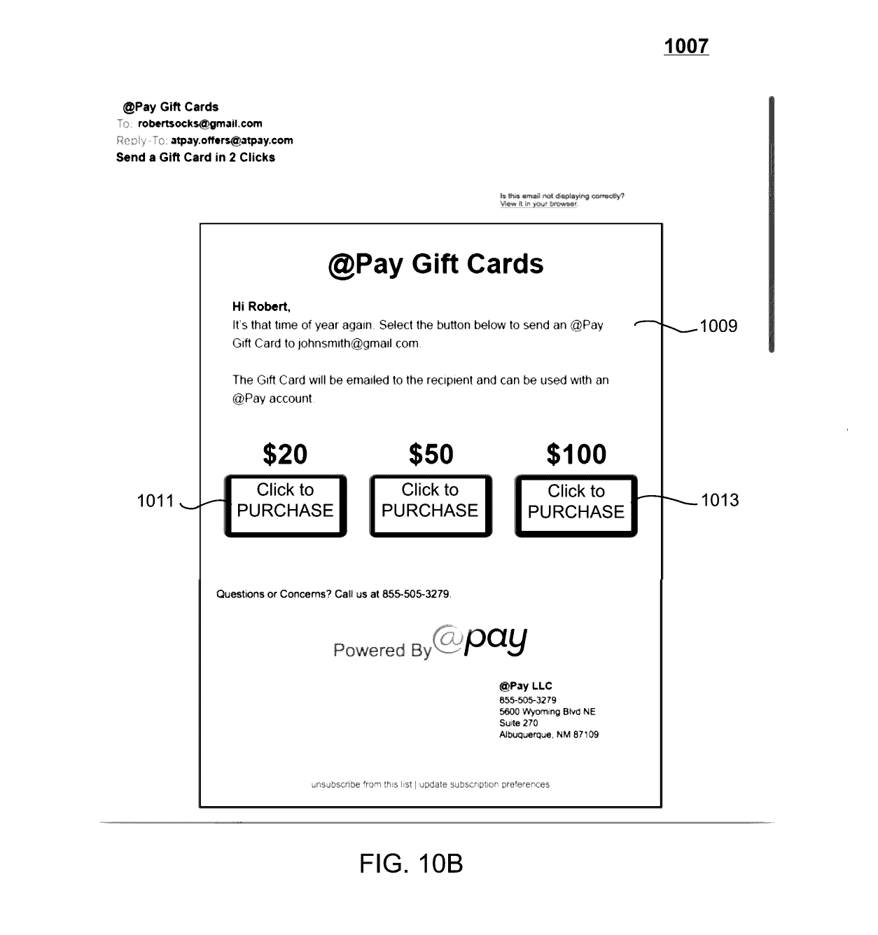

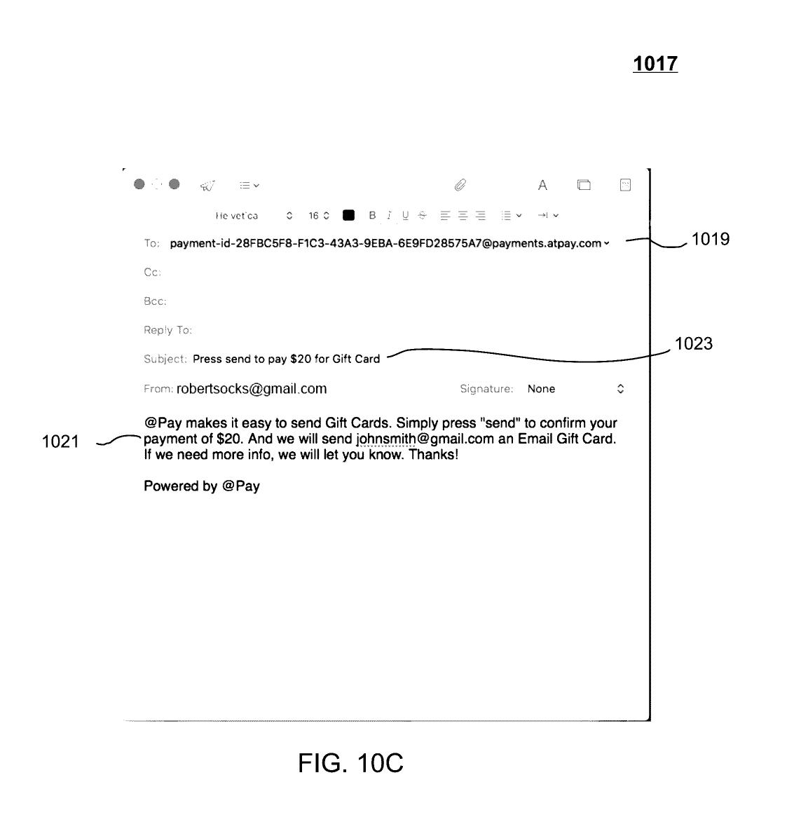

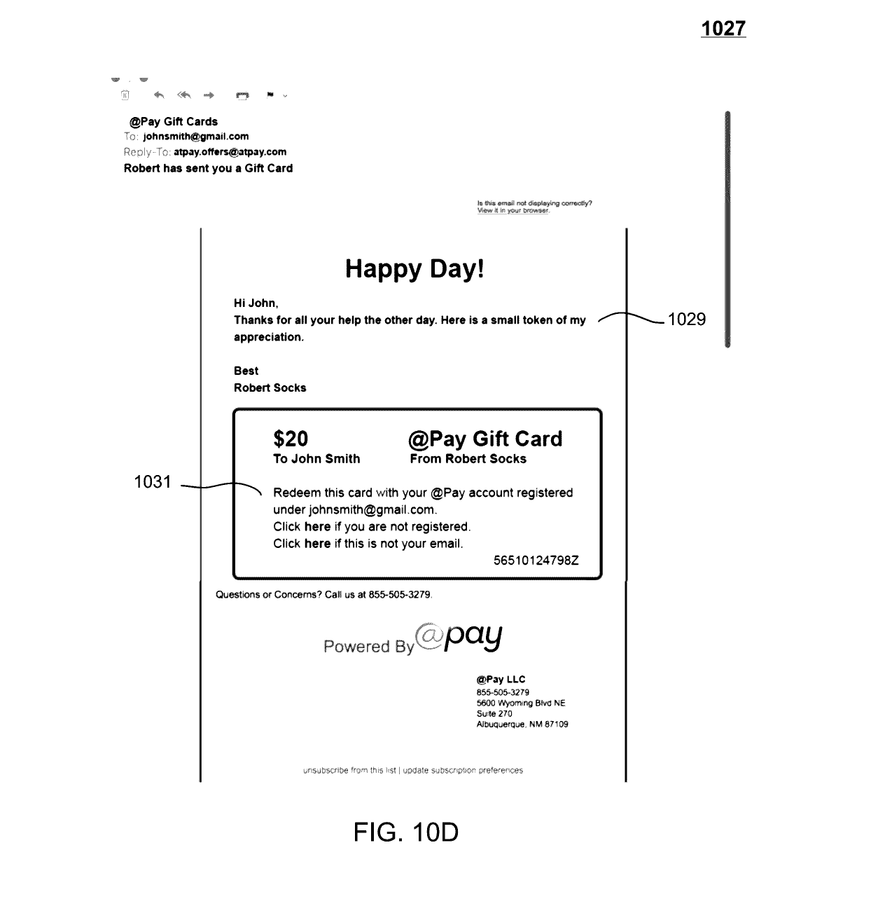

FIG. 10A is a transactional flow diagram 1000 that illustrates how the e-commerce system 140 manages bank accounts or redemption accounts based on deposits made from one customer account 150a to another 150b by messaging. In flow 1000, the parameter unit 171 is triggered at step 1005 based on a set of criteria and shares information at step 1010 with the communication unit 167. This trigger may be the result of multiple factors such as an account running low on funds or a timed alert, for example.

The full-customer 150a is already registered in this discussion, as opposed to the discussion of FIG. 9, with the e-commerce system 140 and therefore does not need to visit a webpage and fill out information. In the case where registration may be required, registration may also occur by a method described in FIG. 7B.

The communication unit 167 generates a gift card offer message at step 1015. FIG. 10B is an example of an offer message 1007 to buy a gift card, the offer being shared by the communication unit 167 and the full-customer 150a at step 1020. As shown, the message is an email 1007. This may be an email 1009 with a mailto link with token embedded behind graphic buttons 1011, 1013. In this example, the graphic buttons 1011, 1013 state ‘Click to Purchase.’ The graphic buttons may also be a SMS or social media post with link, among other methods. There may also be more than one link.

For example, each selection may be for a different amount of money, such as $20 for graphic button 1011 and $100 for graphic button 1013, to be placed into a sub-customer's account. The full-customer 150a makes a selection and generates the response message addressed to the e-commerce system at step 1025.

FIG. 10C is an example of a response message 1017. The message 1017 is addressed to the e-commerce system and includes a token 1019. The token 1019 maybe anywhere in the email. In this depiction, the token 1019 is included in the ‘To’ section. The subject of the message 1017 may identify the action that is being taken 1023. The message 1017 may provide instructions to the reader 1021.

Returning to FIG. 10A, the full-customer shares the message with the e-commerce system's communication unit 167 at step 1030. The message is authenticated at step 1035 and if a token is present, it is decoded. The information may be shared with the parameter unit 171 at step 1040. The parameter unit 171 updates the system at step 1045.

On a condition that the requirements are not met, the e-commerce system may send a confirmation message or a message with a URL that navigates the full-customer to a sign up.

On a condition that all requirements are met, the e-commerce system 140 generates a payment request and shares this with the payment processor 160 at step 1060. The payment processor 160 identifies the accounts and processes the payment at step 1065. The payment processor 160 transfers the funds to the e-commerce system's banking unit 172 at step 1070. Alternatively, the banking unit 172 may transfer the funds to the vendor (not shown) who will redeem the gift card. The banking unit 172 holds the funds in the sub-customer's account at step 1075 and shares the information with the parameter unit 171 at step 1080. The parameter unit is updated at step 1085. The information is shared at step 1090 with the communication unit 167 and notifications are sent out at steps 1095 and 1097.

FIG. 10D is one example of a notification 1027 that the sub-customer 150b may receive informing them of the gift card. This may include instructions 1031 and a graphic representation of a gift card and links to register for an account in the case that the sub-customer 150b is not yet registered along with the comment 1029 from the full-customer 150a.

In an implementation, in FIGS. 9 and 10 the payment processor 160 may be substituted for the e-commerce system's banking unit 172. This may allow customers 150 to transfer funds without accessing their credit card or banking information.

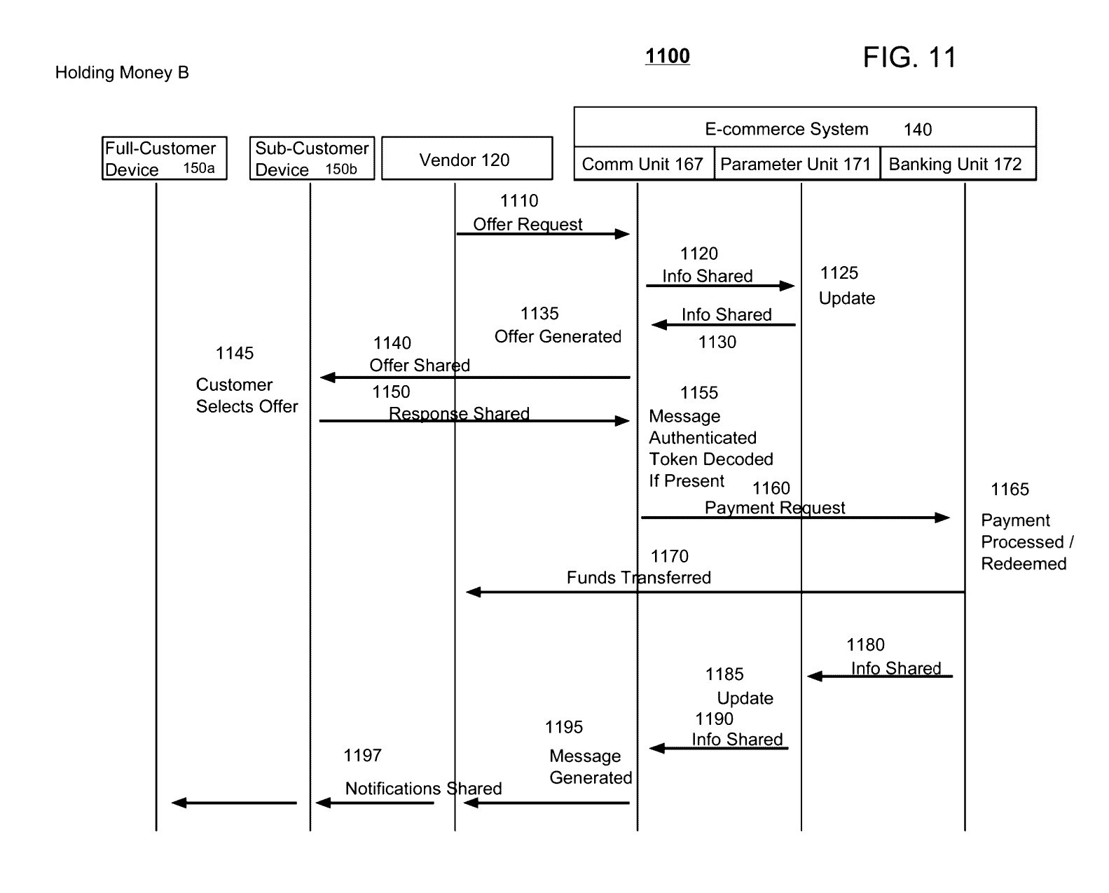

FIG. 11 is a transactional flow diagram 1100 that illustrates a customer accessing funds or redeeming benefits from their account with the e-commerce system 140. The sub-customer 150b may access the gift card's funds, benefits, or credits held in the e-commerce system's banking unit 172. In this example the banking unit 172 is holding money, but it may also securely hold other quantities like time, services, or quantities of product. The vendor 120 requests an e-gift card eligible offer from the e-commerce system's communication unit 167 at step 1110. The communication unit 167 recognizes the vendor 120 and shares the information with the parameter unit 171 at step 1120. This information may include a price or series of prices for a product, service, bill, or donation. The parameter unit 171 updates at step 1125, shares the information with the communication unit 167 at step 1130 and generates an offer message at step 1135. This offer message may have more than one option. The offer message may contain a token. The offer message may contain a mailto link addressed to the e-commerce system 140 with a token or a URL link as described in FIG. 6. The offer message may be an email with a mailto link and a token or an SMS or social media post with a link. The communication unit 167 shares at step 1140 the offer message with the sub-customer device 150b. The offer message may be distributed through multiple avenues or medias by the vendor 120 or other third party.

The sub-customer using the sub-customer device 150b accesses the message and makes a selection at step 1145. The sub-customer device 150b generates the response message. In this example, the sub-customer 150b generates a response message based on the content of an offer message sent to the sub-customer device 150b. For example, by selecting a mailto link or URL link. Alternatively, the sub-customer 150b may generate the message on their own based on other instructions or an advertisement, QR code, and barcode. The response message is addressed to the e-commerce system 140. The response message is shared with the e-commerce system's communication unit 167 at step 1150. The message is authenticated at step 1155 and if a token is present it is decoded. The transaction may require a lookup or an update with the parameter unit 171 (not shown). On a condition that the requirements are not met, the e-commerce system 140 may send a confirmation message or a message with a URL that navigates the customer to a sign up. On a condition that all requirements are met, the e-commerce system 140 generates a payment request and shares it with the banking unit 172 at step 1160. The payment is processed at step 1165. This may not be monetary but may be based on some other unit. The funds are transferred to the vendor 120 at step 1170. The banking unit 172 shares the information with the parameter unit 171 at step 1180 and the parameter unit 171 is updated at step 1185. The parameter unit 171 shares the information with the communication unit 167 at step 1190 and may generate notifications at step 1195 and share them at step 1197. The notifications may be different for each party. For example, a vendor 120 may get a confirmation and the full-customer 150a may get an offer message to add more funds to the sub-customer's 150b account.

Although in this example offers and notifications are sent out by the e-commerce system 140, these offers or access to response messaging may be sent from the vendor 120 or another party. Although in this example there is one full-customer 150a and one sub-customer 150b there may be any number of full-customers and sub-customers. It is possible that a full-customer may grant full-customer rights to another email address. It is also possible that a full-customer may also be a sub-customer of another full-customer.

Also disclosed is a system and method for organizing and prioritizing the method of multiple payment sources when a customer requests a transaction. The e-commerce system 140 enables customers to deposit and access funds from multiple gift cards by associating them with an identifier such as an email address, phone number or social media account. Based on the secure access to those accounts they can request payments be made by sending messages.

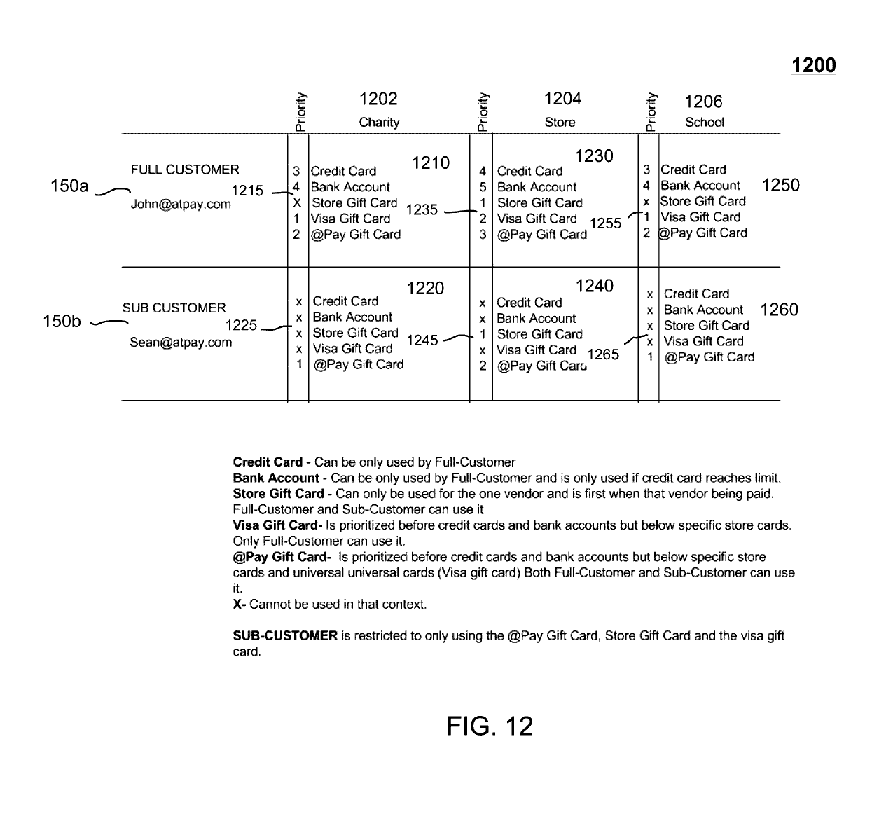

FIG. 12 is a diagram 1200 illustrating the ordering of different payment methods by the e-commerce system 140 for a full-customer 150A with a sub-customer 150B associated with their account. A customer may have more than one method, sources of funds, or credit cards and parameters associated with their email address, phone number, or other identifier. As illustrated, full customer 150a may pay different types of vendors 120, such as a charity 1202, a store 1204, and a school 1206, for example. Different types of payment option may be available to full customer 150a for each vendor 120 and may be prioritized accordingly.

Full customer 150a may have payment choices 1210 available to pay a charity 1202 and prioritized based on priorities 1215. Full customer 150a may have payment choices 1230 available to pay a store 1204 and prioritized based on priorities 1235. Full customer 150a may have payment choices 1250 available to pay a school 1206 and prioritized based on priorities 1255.

Sub customer 150b may have payment choices 1220 available to pay a charity 1202 and prioritized based on priorities 1225. Sub customer 150b may have payment choices 1240 available to pay a store 1204 and prioritized based on priorities 1245. Sub customer 150b may have payment choices 1260 available to pay a school 1206 and prioritized based on priorities 1265.

For example, a gift card (priorities 1 and 2 in priorities 1215) may be prioritized to be spent first before charges are placed on a credit card (priority 3 in priorities 1215). This may be a default setting or controlled by one of the parties.

In another example, a gift card may only be used with certain vendors and the requirement may be defined by the vendor policy. The e-commerce 140 may determine if the vendor 120 is requesting the payment and apply the charges appropriately. Each vendor 120 may require a different order of priority.

In this example the available funds are a credit card, bank account, store gift card, visa gifts card, @Pay gift card. Each of these methods may have different requirements. The credit card may be only used by a full-customer 150a (priority x in priorities 1225, 1245, 1265). The bank account access may only be used by the full-customer 150a and is only used if credit card reaches limit. The store gift card may only be used for the one vendor 120 and is first when that vendor 120 is being paid. The Visa gift card is prioritized before credit cards and bank accounts but below specific store cards. Only full-customer 150a may use the Visa Gift Card. The @Pay gift card is prioritized before credit cards and bank accounts but below specific store cards and universal cards (Visa gift card), both full-customer 150a and sub-customer 150b may use it. The @Pay gift card represents a version of a gift card that may be exclusive to the e-commerce system 140. The ‘X’ designation means that the funds associated with that account cannot be accessed in that context.

The e-commerce system 140 allows the customer 150 or vendor 120 to order, allow, or restrict access to accounts based on parameters set by the customer 150, vendor 120, or e-commerce system 140. In this implementation, there are different priorities for each customer 150 determined by vendor 120 relationship. As illustrated in diagram 1200, the vendors 120 may include a charity 1202, a store 1204 and a school 1206. The system 140 determines priority based on the vendor 120, customer 140, and method of payment requirements.

This may also be used for virtual currencies and the system applies charges where appropriate. These currencies may exist entirely in the e-commerce system 140 or the virtual units may be able to be redeemed for money such as the US dollar.

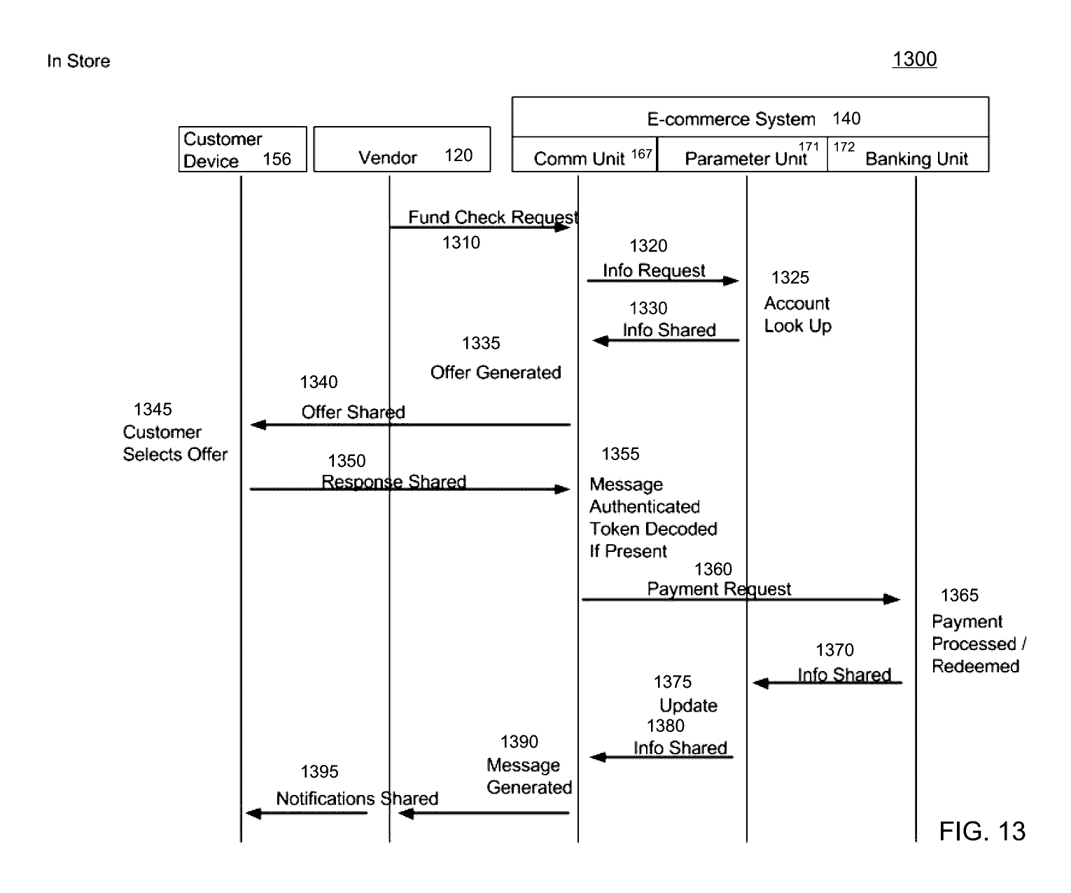

FIG. 13 is a transactional flow diagram 1300 that illustrates a in store vendor 120 requesting a payment from a customer account with the e-commerce system 140. The customer 150 may access funds, benefits, or credits held in the banking unit 172. The customer may hold a physical card linked to their e-commerce system 140 account or may only require their email address, phone number, social media and/or other identifier. In this illustration, the banking unit 172 is holding money for use by the customer 150, although the banking unit 172 may securely hold other quantities like credits for time, services, or quantities of product. In this illustration, a customer who is shopping in a brick and mortar store may desire to use a gift card or other card, although a physical card may not be required because their gift cards are associated with their email account or other identifier. The vendor 120 may request payment by providing the e-commerce system 140 the customer's email and then sends a customer a message for confirmation.

The customer informs the vendor 120 of their email address or other identifier which is associated with their account with the e-commerce system 140. The vendor 120 shares the address with the e-commerce system 140 at the communication unit 167 and requests a check on funds at step 1310 and an offer message be sent to the customer. The e-commerce system communication unit 167 receives the request and shares the request the parameter unit 171 at step 1320. The parameter unit 171 checks the account for funds at step 1325.

If the funds are not available, the vendor 120 is sent a transaction rejection. If the requirements are met and funds are available, the parameter unit 171 updates and shares the information with the communication unit 167 at step 1330. The communication unit 167 generates an offer message at step 1335 addressed to the customer device 150. This offer message may have more than one option. The offer message may contain a token. The offer message may contain a mailto link addressed to the e-commerce system 140 with a token or a URL link as described in FIG. 6. The offer message may be an email with a mailto link and a token or an SMS or social media post with a link.

The communication unit 167 shares the offer message with the customer device 150 at step 1340. The offer message may be distributed through multiple avenues or media by the vendor 120 or other third party. The offer message may be an email with a mailto link and a token or an SMS, social media post, or email with a link. Alternatively, the customer and vendor 120 may receive a secret pin which the customer is required to show or tell the customer or vendor 120 to confirm and complete the purchase.

The customer using the customer device 150 accesses the message and makes a selection at step 1345. The customer device 150 generates the response message. In this example, the customer generates a response message based on the content of an offer message sent to the customer device 150. The token may be anywhere in the message. The response message is shared with the e-commerce system's communication unit 167 at step 1350. The message is authenticated at step 1355 and if a token is used, it is decoded. The transaction may require a lookup or an update with the parameter unit 171 (not shown). On a condition that the requirements are not met, the e-commerce system 140 may send a confirmation message or a message with a URL that navigates the customer to a sign up. On a condition that all requirements are met, the e-commerce system 140 generates a payment request and shares it with the banking unit 172 at step 1360. The payment is processed or redeemed at step 1365 based on the requirements in the parameter unit 171. This may not be monetary, for example, it may be based on time or services.

The banking unit 172 shares the information with the parameter unit 171 at step 1370 and the parameter unit 171 is updated at step 1375. The parameter unit 171 shares the information with the communication unit 167 at step 1380 and may generate notifications at step 1390 and share them at step 1395. The notifications may be different for each party. For example, a vendor 120 may get a confirmation and the customer may get a receipt with the remaining balance in their account.

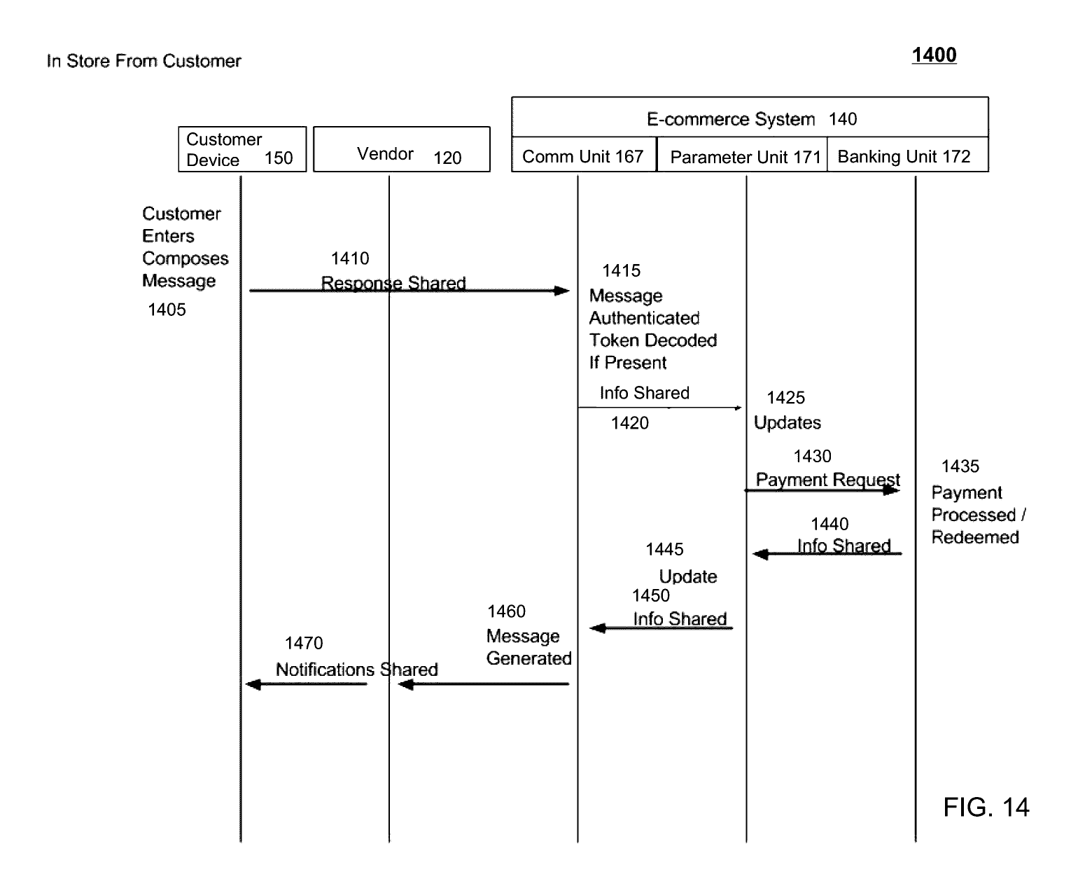

FIG. 14 is a transactional flow diagram 1400 that illustrates an in store customer initiating a gift card payment with the e-commerce system 140. The customer may access funds, benefits, or credits held in the banking unit 172. The customer may hold a physical card linked to their e-commerce system 140 account or may only require their email address, phone number, and/or other identifier. In this illustration, the banking unit 172 is holding money for use by the customer, although the banking unit 172 may securely hold other quantities like credits for time, services, or quantities of product. In this illustration, a customer shopping in a brick and mortar store may desire to use a gift card or other card, although the physical card may not be needed because their gift cards are associated with their email account. The vendor 120 may tell the customer the final amount to pay and the customer may request payment by sending a message to the e-commerce system 140.

The vendor 120 informs the customer of the total amount owed and the address to send the message. This payment may be for a donation, product or service. The customer using the customer device 150 generates a message address to the e-commerce system 140 with the amount they wish to pay at step 1405. The destination of the address may be the e-commerce system 140 although the address may be associated with the vendor 120 or the vendor 120 specific gift card.

The customer shares this message with the e-commerce system 140 at the communication unit 167 at step 1410. The message is authenticated at step 1415 and the email decoded based on the email address of the e-commerce system 140 associated with the vendor account and the amount to be charged included in the customer message. On a condition that the requirements are not met, the e-commerce system 140 may send a confirmation message or a message with a URL that navigates the customer to a sign up. On a condition that all requirements are met, the e-commerce system 140 shares the request and information with the parameter unit 171 at step 1420. The parameter unit 171 updates at step 1425. The parameter unit 171 determines if conditions are met and requests the payment from the banking unit 172 at step 1430. The payment is processed or redeemed at step 1435 based on the requirements in the parameter unit 171. This may not be monetary, for example, it may be based on time or services. The banking unit 172 shares the information with the parameter unit 171 at step 1440 and the parameter unit 171 is updated at step 1445. The parameter unit 171 shares the information with the communication unit 167 at step 1450. The communication unit 167 may generate notifications at step 1460 and share them at step 1470. The notifications may be different for each party. For example, a vendor 120 may get a confirmation and the customer may get a receipt with the remaining balance in their account.

Alternatively the e-commerce system 140 may require and additional confirmation message from the customer. The e-commerce system 140 may send an offer message to the customer to confirm the details of the transaction. The offer message may contain a token. The offer message may contain a mailto link addressed to the e-commerce system 140 with a token or a URL link as described in FIG. 6. The offer message may be an email with a mailto link and a token or an SMS or social media post with a link.

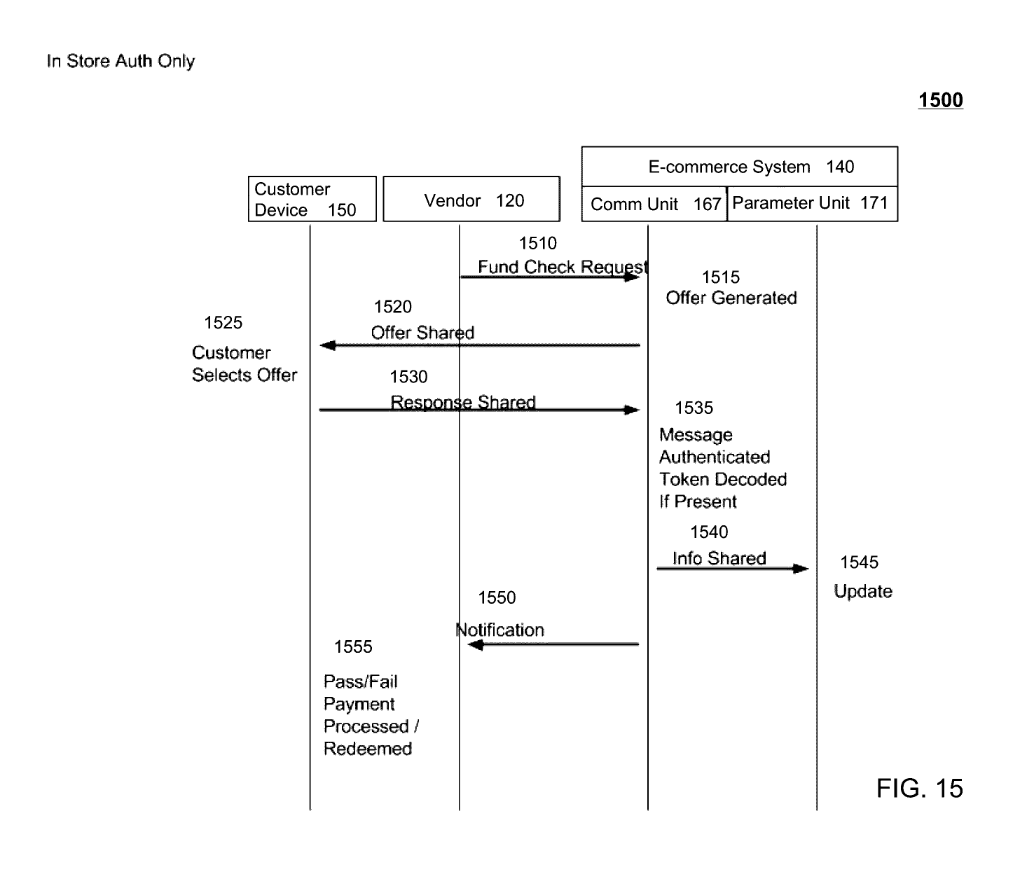

FIG. 15 is a transactional flow diagram 1500 that illustrates how an in store vendor 120 requests authentication of a message with the e-commerce system 140 for the purposes of gift card redemption. Vendors 120 sell and distribute gift cards to customers. The customer may access funds, benefits, or credits held in the banking unit 172. The customer may hold a physical card linked to their e-commerce system account or may only require their email address, phone number, and/or other identifier. In this example funds of a gift card. The banking unit 172 or payment processing may be controlled by the vendor 120. In this illustration, a customer who is shopping in a brick and mortar store may desire to use a gift card or other card, and may not need the physical card because their gift cards are associated with their email account or other identifier. The vendor 120 may use the e-commerce system 140 to authenticate an email or other message format.

The customer informs the vendor 120 of their email address or other identifier which is associated with their account with the e-commerce system 140. The vendor 120 shares the address with the e-commerce system 140 at the communication unit 167 and requests an offer message be sent to the customer at step 1510. The communication unit 167 generates an offer message addressed to the customer device at step 1515. This offer message may have more than one option. The offer message may contain a token. The offer message may contain a mailto link addressed to the e-commerce system with a token or a URL link as described in FIG. 6. The offer message may be an email with a mailto link and a token or an SMS or social media post with a link.

The communication unit 167 shares the offer message with the customer device at step 1520. The offer message may be distributed through multiple avenues or media by the vendor 120 or other third party. The offer message may be an email with a mailto link and a token or an SMS, social media post, or email with a link. Alternatively, the customer and vendor 120 may receive a secret pin which the customer is required to show or tell the customer or vendor 120 to confirm and complete the purchase.

The customer using the customer device 150 accesses the message and makes a selection at step 1525. The customer device 150 generates the response message. In this example, the customer generates a response message based on the content of an offer message sent to the customer device. The token may be reside anywhere in the message.

The response message is shared with the e-commerce system's communication unit 167 at step 1530. The message is authenticated at step 1535 and if a token is used, it is decoded. The transaction may require a lookup or an update with the parameter unit 171 (not shown). The communication unit 167 determines whether the authentication is pass or fail. On a condition that the requirements are not met, the e-commerce system 140 may send a confirmation message or a message with a URL that navigates the customer to a sign-up. The communication unit 167 shares the information at step 1540 with the parameter unit 171. The parameter unit 171 updates at step 1545. The communication unit 167 notifies the vendor 120 of the outcome of the authentication at step 1550. The payment is processed or redeemed based on the requirements of the authentication at step 1555.

The above examples utilize the @Pay e-commerce system's capacity to approve payments using secure email, SMS and/or social media. It assumes that the customer/holder of the credit card or bank account does not share the credit card information or their message account password with other people. A customer with multiple gift cards or forms of redemption may associate all these with their e-commerce system account. Additionally the e-commerce system may issue the customer a physical card that is associated with their e-commerce system account (email address, phone number and or other). Both the card and the email address may be used to access the resources. The card may be a plastic magnetic strip card, barcode, QR code, NFC chip, image recognition or other form of physical identification.

What is claimed is:

1. A method for gift cards, account controls, and payment processor integration with email payment in an e-commerce system, the method comprising:
receiving parameters, from a full-customer, for a sub-customer to access an account of the full-customer, wherein the full-customer provides an identifier of the sub-customer;
receiving a confirmation from the sub-customer confirming the received parameters;
transmitting an offer to the sub-customer, wherein the offer includes a mailto link and a token;
receiving a message from the sub-customer, wherein the sub-customer selects the mailto link in the offer;
checking the parameters set by the full-customer; and
on a condition that the parameters are met, processing a payment.

2. The method of claim 1, wherein the received message is authenticated by based on an address where the received message originated.

3. The method of claim 1, wherein the received message is an email message.

4. The method of claim 1, wherein the received message is a Short Message Service (SMS) message.

5. The method of claim 1, wherein checking parameters includes comparing the offer to selected uses allowing the access.

6. A method for gift cards, account controls, and payment processor integration with email payment in an e-commerce system, the method comprising:
transmitting a gift offer to a full-customer, wherein the gift offer includes a mailto link and a token;
receiving a message from the full-customer to transmit a gift to a sub-customer, the message sent when the full-customer selects the mailto link in the gift offer;
authenticating the message and decoding the token;
checking parameters set by the full-customer; and
on a condition that the parameters are met, transferring the gift to the sub-customer from the full-customer.

7. The method of claim 6, wherein the authenticating is based on an address where the received message originated.

8. The method of claim 6, wherein the received message is an email message.

9. The method of claim 6, wherein the received message is a Short Message Service (SMS) message.

10. The method of claim 6, wherein checking parameters includes comparing the offer to selected uses allowing the access.

11. A method for gift cards, account controls, and payment processor integration with email payment in an e-commerce system, the method comprising:
transmitting an offer to a sub-customer, wherein the offer includes a mailto link and token;
receiving a response message from the sub-customer, wherein the sub-customer selects the mailto link in the offer;
authenticating the response message and decoding the token;
checking parameters set by a full-customer; and
on a condition that the parameters are met, processing a payment.

12. The method of claim 11, wherein the authenticating is based on an address where the received message originated.

13. The method of claim 11, wherein the received message is an email message.

14. The method of claim 11, wherein the received message is a Short Message Service (SMS) message.

15. The method of claim 11, wherein checking parameters includes comparing the offer to selected uses allowing the access.

16. A method for gift cards, account controls, and payment processor integration with email payment in an e-commerce system, the method comprising:
receiving a request for a check of available funds from a vendor;
transmitting an offer to a customer, wherein the offer includes a mailto link and a token;
receiving a response message from the customer verifying a purchase, wherein the customer selects the mailto link in the offer;
authenticating the message and decoding the token; and
on a condition that the authenticating is met, processing a payment for the purchase.

17. The method of claim 16, wherein the authenticating is based on an address where the received message originated.

18. The method of claim 16, wherein the received message is an email message.

19. The method of claim 16, wherein the received message is a Short Message Service (SMS) message.

20. The method of claim 16, wherein the authenticating uses DKIM/SPF protocol.
